(19) United States
(12) Patent Application Publication
(10) Pub. No.: US 2026/0278897 A1
(43) Pub. Date: Sep. 17, 2026

(54) METHODS, SYSTEMS, AND APPARATUSES FOR GENERATING ANIMATION PATHS FOR AUGMENTED REALITY

(71) Applicant: George Mason University, Fairfax, VA (US)

(72) Inventors: Lap-Fai Yu, Fairfax, VA (US); Minyoung Kim, Fairfax, VA (US)

(21) Appl. No.: 19/563,645

(22) Filed: Mar. 11, 2026

Related U.S. Application Data
(60) Provisional application No. 63/770,091, filed on Mar. 11, 2025.

(51) Int. Cl. G06T 13/20; G06F 3/01; G06T 19/00

(52) U.S. Cl. CPC G06T 13/20; G06F 3/011; G06T 19/006

(57) ABSTRACT

Methods, systems, and apparatuses for generating animation paths for virtual characters in outdoor augmented reality environments are described. A trained prediction model analyzes a three-dimensional representation of an environment to identify suitable locations for performing character actions in the environment. Waypoints are selected within the three-dimensional representation based on the identified locations, with each waypoint corresponding to a location where the virtual character performs a storyline action. An animation path connecting the selected waypoints is synthesized and optimized based on visibility from a user perspective, distance from the user, and path smoothness.

### CROSS REFERENCE TO RELATED PATENT APPLICATION

This application claims priority to U.S. Provisional Application No. 63/770,091, filed Mar. 11, 2025, which is herein incorporated by reference in its entirety.

### FEDERALLY SPONSORED RESEARCH AND DEVELOPMENT

This invention was made with government support under grant number 1942531 and 2128867 awarded by the National Science Foundation. The government has certain rights in the invention.

### BACKGROUND

Augmented reality (AR) technologies have emerged as a medium for delivering immersive experiences that overlay virtual content onto real-world environments. These technologies enable users to view and interact with virtual characters and objects as if they existed within their physical surroundings. AR devices, including head-mounted displays and mobile devices, have become increasingly lightweight and wireless, expanding the potential for AR experiences beyond indoor settings to large-scale outdoor environments.

Creating animated content for AR presents challenges that differ from traditional animation or virtual reality content creation. Unlike pre-rendered animations or virtual environments where the viewing context is controlled, AR-based content must adapt to the physical environment in which it is displayed and to the user's position and viewpoint within that environment. A virtual character animated in AR should interact with the real-world surroundings in a manner that appears natural and contextually appropriate.

Existing approaches to AR character animation have attempted to leverage scene information such as scene semantics or scene geometry to enhance the realism of virtual character interactions with real-world environments. However, many of these approaches have focused on indoor scenes where the environment is relatively constrained and predictable. Outdoor environments present additional complexity due to their larger scale, varied terrain, and diverse environmental features such as bodies of water, vegetation, and architectural structures.

Pathfinding algorithms, including grid-based search algorithms and sampling-based methods, have been developed for robotics and computer graphics applications. While these algorithms can compute paths between locations, they typically do not account for user-oriented factors such as visibility from the user's perspective or semantic compatibility between character actions and environmental features. Approaches developed for aerial path generation, such as those for drone navigation or virtual winged characters, have focused on objectives specific to those applications rather than on delivering user-centered AR experiences.

AR storytelling applications have explored methods for creating interactive content and extending physical media into augmented experiences. Some approaches have addressed the challenge of adapting AR content to different locations or enabling user participation in AR narratives. However, generating animation paths that remain visible to users as they move through an outdoor environment while placing character actions at semantically appropriate locations presents ongoing technical challenges. The alignment between virtual content and real-world geometry, the handling of dynamic user viewpoints, and the automatic selection of contextually compatible locations for character behaviors represent areas where improvements in AR content generation techniques would be beneficial.

### SUMMARY

It is to be understood that both the following general description and the following detailed description are exemplary and explanatory only and are not restrictive.

Methods, apparatuses, and systems for generating animation paths for virtual characters in augmented reality environments, such as for outdoor settings, are described. A trained prediction model analyzes a three-dimensional representation of a real-world environment to determine location compatibility values indicating how suitable different locations are for performing various character actions such as drinking, eating, sitting, sleeping, or swimming. Based on these compatibility values, waypoints are selected where the virtual character will perform storyline actions, and an animation path connecting these waypoints is synthesized using optimization techniques that account for visibility from the user's perspective, distance from the user, and path smoothness.

In an embodiment, disclosed are methods comprising generating, by a computing device, based on image data of an environment, a three-dimensional (3D) representation of the environment, determining a sequence of actions associated with an object for insertion in an augmented reality display, determining, by a machine learning model, based on data indicative of the 3D representation of the environment and data indicative of the sequence of actions associated with the object, one or more waypoints within the 3D representation of the environment for the object to perform the sequence of actions, and generating an animation path connecting the one or more waypoints, wherein the object performs the sequence of actions in the augmented reality display along the animation path according to the one or more waypoints.

In an embodiment, disclosed are methods comprising receiving, by a computing device, image data of an environment within a viewpoint of a user, generating, based on the image data of the environment, a three-dimensional (3D) representation of the environment within the viewpoint of the user, determining, by a machine learning model, based on data indicative of the 3D representation of the environment within the viewpoint of the user and data indicative of a sequence of actions associated with an object, one or more waypoints within the 3D representation of the environment for the object to perform the sequence of actions within the viewpoint of the user, generating an animation path connecting the one or more waypoints, and displaying, via an augmented reality display, an overlay of the object performing the sequence of actions according to the animation path within the viewpoint of the user.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows an example system for generating animation paths;

FIG. 2 shows an example process for determining location compatibility;

FIG. 3 shows an example process for determining one or more waypoints;

FIG. 4 shows an example 3D scene;

FIGS. 5A-5B show examples of a feature extraction process;

FIG. 6 shows an example 3D scene;

FIGS. 7A-7E show example location compatibility maps;

FIGS. 8A-8F show example waypoints and animation paths;

FIGS. 9A-9E show example animation paths;

FIGS. 10A-10B show an example environment;

FIGS. 11A-11B show examples of user viewpoints of an environment;

FIGS. 12A-12B show examples of animation paths;

FIG. 13 shows example system architecture;

FIG. 14 shows example system architecture;

FIG. 15 shows a flowchart of an example method for generating an animation path; and

FIG. 16 shows a flowchart of an example method for generating an animation path.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

As used herein the terms “individual,” “patient,” “subject,” “user,” or “person” may indicate a person associated with the determination of one or more physiological parameters, such as an interstitial insulin elimination rate, a hepatic insulin elimination rate, a renal insulin elimination rate, or a permeability constant related to insulin diffusion in the human body.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, the methods and systems may take the form of a computer program product on a computer-readable storage medium (e.g., non-transitory) having processor-executable instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks. In addition, some of these functions may be carried out using complex programmable logic devices (CPLDs) or other programmable logic devices.

The processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks. In addition, some of these functions may be carried out using logic devices which do not operate by sequential operations of programmed steps.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions and logic circuitry.

Methods and systems are described for generating an animation path for a virtual character in an augmented reality environment. For example, a sequence of storyline actions to be performed by the virtual character and a three-dimensional (3D) representation of a real-world environment may be determined. The 3D representation may comprise a voxel set with an adaptive octree structure, wherein voxels within the voxel set vary in size depending on whether enclosed the 3D representation contains scene geometry. A trained prediction model may determine location compatibility values for locations within the 3D representation, wherein each location compatibility value may indicate a compatibility of a respective location for performing a respective storyline action from the sequence of storyline actions. The trained prediction model may comprise a few-shot learning model employing a feature extractor, such as a neural network configured to extract image features from location images, and a fine-tuned predictor. Waypoints may then be selected within the 3D representation based on the location compatibility values, wherein each waypoint may correspond to a location where the virtual character is to perform a respective storyline action. An animation path connecting the selected waypoints may be synthesized and optimized based on visibility from a user perspective, a distance cost based on distances between voxels and a user position, and a smoothness cost based on angle changes along the animation path. The path synthesis may apply a modified A* algorithm, wherein a visibility cost for a voxel may be calculated by performing an occlusion test for corners and a center of the voxel. The animation path may be updated based on a change in user position or orientation, and the virtual character may be rendered along the computed path via an augmented reality display device.

The methods and systems provide technical improvements over prior approaches to augmented reality character animation. The adaptive octree structure for the voxel-based 3D representation reduces computational overhead by varying voxel resolution based on scene geometry density, thereby decreasing memory requirements and processing time for path computation in large-scale outdoor environments. The few-shot learning approach for location compatibility prediction enables the system to generalize to new environments with limited training data, reducing the data collection and model training burden associated with conventional machine learning approaches. The incorporation of a visibility cost, a distance cost, and a smoothness cost into path synthesis produces animation paths that maintain user visibility while avoiding computationally expensive and exhaustive search methods. The methods and systems produce optimal waypoint configurations without requiring enumeration of all possible waypoint combinations.

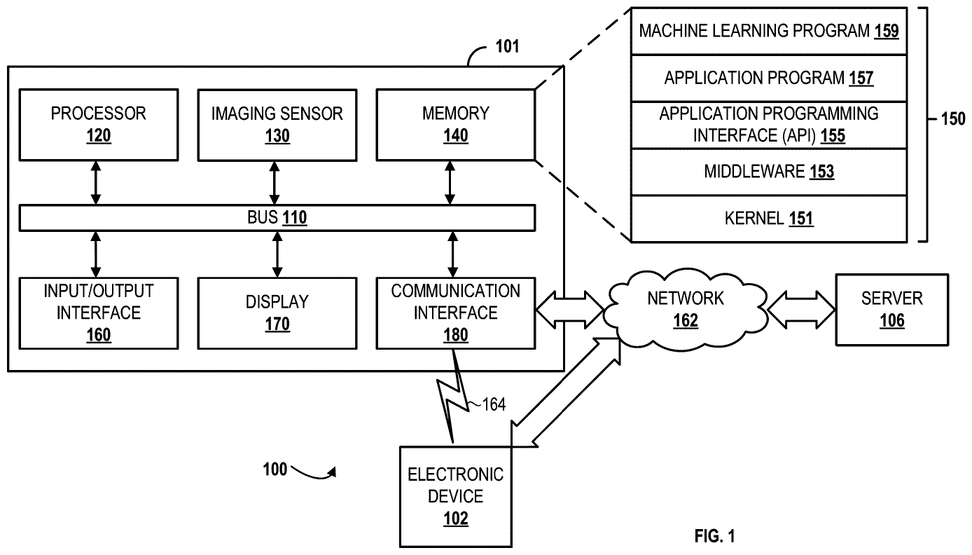

FIG. 1 shows an example system 100 for generating an animation path for a virtual character in an augmented reality environment. Referring to FIG. 1, the system 100 may comprise a computing device 101. The computing device 101 may comprise, for example, a head-mounted display (HMD) device (e.g., an augmented reality headset), a mobile phone, a smart phone, a tablet computer, a laptop, a desktop computer, a smartwatch, and the like. As an example, the HMD may be configured to include an optical element that may selectably turn on or off a view of an outside environment within a viewpoint of a user (e.g., in front of the user's eyes). As an example, the computing device 101 and the external device may be integrated together as a single device or may comprise separate devices. The computing device 101 may include a bus 110, one or more processors 120, an imaging sensor 130, a memory 140, an input/output interface 160, a display 170, and a communication interface 180. In an example, the computing device 101 may omit at least one of the aforementioned constitutional elements or may additionally include other constitutional elements.

The bus 110 may include a circuit for connecting the bus 110, the one or more processors 120, the imaging sensor 130, the memory 140, the input/output interface 160, the display 170, and/or the communication interface 180 to each other and for delivering communication (e.g., a control message and/or data) between the bus 110, the one or more processors 120, the imaging sensor 130, the memory 140, the input/output interface 160, the display 170, and/or the communication interface 180.

The one or more processors 120 may include one or more of a Central Processing Unit (CPU), an Application Processor (AP), and a Communication Processor (CP). The one or more processors 120 may control, for example, at least one of the bus 110, the imaging sensor 130, the memory 140, the input/output interface 160, the display 170, and/or the communication interface 180 and/or may execute an arithmetic operation or data processing for communication. The processing (or controlling) operation of the one or more processors 120 according to various embodiments is described in detail with reference to the following drawings.

The imaging sensor 130 may comprise one or more imaging, or image, capture devices such as one or more cameras. As an example, the image sensor 130 may be configured to capture image data (e.g., video, one or more images, etc.) of an environment within a viewpoint of the user. The environment may comprise one or more characteristics. The one or more characteristics may comprise one or more of one or more objects, one or more buildings, one or more roads, one or more terrain features, and the like. The one or more terrain features may comprise one or more of one or more bodies of water, one or more hills, one or more plants, one or more mountains, and the like.

The processor-executable instructions executed by the one or more processor 120 may be stored and/or maintained by the memory 140. The memory 140 may include a volatile and/or non-volatile memory. The memory 140 may store, for example, a command or data related to at least one different constitutional element of the electronic device 101. According to various exemplary embodiments, the memory 140 may store a software and/or a program 150. The program 150 may include, for example, a kernel 151, a middleware 153, an Application Programming Interface (API) 155, an application program (or an “application”) 157, and/or a machine learning program/module 159, or the like, configured for controlling one or more functions of the computing device 101 and/or an external device. At least one part of the kernel 151, middleware 153, or API 155 may be referred to as an Operating System (OS). The memory 140 may include a computer-readable recording medium having a program recorded therein to perform the method according to various embodiments by the processor 120.

The kernel 151 may control or manage, for example, system resources (e.g., the bus 110, the processor 120, the memory 140, etc.) used to execute an operation or function implemented in other programs (e.g., the middleware 153, the API 155, the application program 157, or the machine learning program/module 159). Further, the kernel 151 may provide an interface capable of controlling or managing the system resources by accessing individual constitutional elements of the computing device 101 in the middleware 153, the API 155, the application program 157, or the machine learning program/module 159.

The middleware 153 may perform, for example, a mediation role so that the API 155, the application program 157, or the machine learning program/module 159 can communicate with the kernel 151 to exchange data. Further, the middleware 153 may handle one or more task requests received from the application program 157 or the machine learning program/module 159 according to a priority. For example, the middleware 153 may assign a priority of using the system resources (e.g., the bus 110, the processor 120, or the memory 140) of the computing device 101 to at least one of the application programs 157 and/or the machine learning program/module 159. For instance, the middleware 153 may process the one or more task requests according to the priority assigned to the at least one of the application programs, and thus may perform scheduling or load balancing on the one or more task requests.

The API 155 may include at least one interface or function (e.g., instruction), for example, for file control, window control, video processing, or character control, as an interface capable of controlling a function provided by the application program 157 in the kernel 151 or the middleware 153.

The application program 157 may include logic (e.g., hardware, software, firmware, etc.) that may be implemented to generate an animation path for a virtual character in an augmented reality environment. The computing device 101 may receive image data via the imaging sensor 130. As an example, the application program 157 may cause the computing device 101 to generate a three-dimensional (3D) representation of the environment (e.g., a 3D scene). For example, the computing device 101 may generate a 3D representation of the environment from the image data captured by the image sensor 130. In an example, the computing device 101 may access location information (e.g., GPS information) and a location database (e.g., Google maps, Google earth, etc.) in order to retrieve image data, via the location database, associated with the computing device's 101 location. In one example, the computing device 101 may generate the 3D representation of the environment based on the image data associated with the computing device's 101 location. In another example, the computing device 101 may generate the 3D representation of the environment based on a combination of the image data captured by the image sensor 130 and the image data associated with the computing device's 101 location.

The application program 157 may also cause the computing device 101 to determine a sequence of actions associated with an object for insertion in an augmented reality display (e.g., display 170). In an example, the computing device 101 may determine a plurality of sequences of actions associated with the object. For example, the plurality of sequences of actions may be stored (e.g., as a data file) on the computing device 101 (e.g., in the memory 140) or may be stored in an external device (e.g., on a server such as server 106). The computing device 101 may retrieve the plurality of sequences of actions and the application program 157 may cause the computing device 101 to implement the machine learning program 159 to select the sequence of actions from the plurality of sequences of actions based on the plurality of sequences of actions and the data indicative of the 3D representation of the environment. For example, the computing device may select the sequence of actions from the plurality of sequences of actions based on a compatibility of the sequence of actions with one or more locations within the 3D representation of the environment. The object may comprise a virtual character, a virtual object, and the like.

The application program 157 may cause the computing device 101 to implement the machine learning program 159 to determine one or more waypoints within the 3D representation of the environment for the object to perform the sequence of actions based on data indicative of the 3D representation of the environment and data indicative of the sequence of actions associated with the object. For example, the application program 157 may cause the computing device 101 to implement the machine learning program 159 to determine one or more compatibility values associated with one or more locations within the 3D representation of the environment based on the data indicative of the 3D representation of the environment and the data indicative of the sequence of actions associated with the object. The application program 157 may determine the one or more waypoints within the 3D representation of the environment for the object to perform the sequence of actions based on the one or more compatibility values.

As an example, adaptive object animations may be synthesized by analyzing scene semantic information of the environment (e.g., via the 3D representation of the environment). For example, waypoints may be sampled where the object will perform its storyline actions. For example, the application program 157 may be configured to analyze locations in the environment to determine the locations' compatibility for performing the object's storyline actions. For example, for an object comprising a dragon in augmented reality, an environment comprising various inherent semantic information and relevant interactions for a dragon may include watery areas for drinking, shady areas for sleeping, and the like. The machine learning program 159 may be utilized to determine the suitable scene regions for the dragon to perform different character/storyline actions.

The application program 157 may cause the computing device 101 to generate an animation path connecting the one or more waypoints. For example, the object may perform the sequence of actions in the augmented reality display along the animation path according to the one or more waypoints. For example, the application program 157 may cause the computing device 101 to generate the animation path connecting the one or more waypoints based on one or more of a location compatibility cost, a visibility cost, a distance cost, or a smoothness cost. The location compatibility cost may be based on a compatibility of an action of the sequence of actions with a voxel of the 3D representation of the environment. The visibility cost may be based on voxels of the 3D representation of the environment that are outside of a viewpoint of a camera capturing the environment and voxels of the 3D representation of the environment that are occluded by one or more of the characteristics of the environment. The distance cost may be based on a distance between a position of a user and voxels of the 3D representation of the environment. The smoothness cost may be based on one or more angle changes between consecutive segments of the animation path.

As an example, an optimal animation path may be generated that takes into account the user's current status and surroundings based on an input sequence of the object's storyline actions. By considering the user's position and viewpoint when generating the paths for augmented reality animations in the real word, the user may be kept visually engaged with the augmented reality display/content. For example, an animation path may be synthesized via an optimization. For example, an input scene comprising the environment may be analyzed in order to understand the input scene's context, the waypoints may be determined where the object should perform the sequence of actions (e.g., storyline's actions), and an optimal animation path may be identified (e.g., determined) while considering storyline action waypoints and the user's perspective.

In an example, the application program 157 may cause the computing device 101 to generate an overlay of the object performing the sequence of actions according to the animation path. The computing device 101 may display the overlay of the object performing the sequence of actions according to the animation path within a viewpoint of a user of the augmented reality display via the augmented reality display (e.g., display 170). As an example, the user wearing an AR headset (e.g., the computing device 101) may watch the object animated via the synthesized animation path, performing the sequence of storyline actions at semantically compatible places within the user's surroundings (e.g., viewpoint) in the real world.

In an example, the application program 157 may cause the computing device 101 to determine one or more of a change in a position of a user of the computing device or a change in a viewpoint of the user. The application program 157 may cause the computing device 101 to update the animation path based on one or more of the change in the position of the user or the change in the viewpoint of the user. For example, the generated animation paths may be adapted to the user and the environment in order to deliver immersive augmented reality experiences.

The input/output interface 160 may be configured as an interface for delivering an instruction or data input from a user or a different external device(s) to the processor 120, the memory 140, the display 170, and the communication interface 180. For example, the input/output interface 160 may receive user input for programming the computing device 101. For example, the input/output interface 160 may receive user input for activating the computing device 101 (e.g., AR headset) in order to generate the augmented reality display of the object performing the sequence of actions along the animation path according to the one or more waypoints. In an example, the user may provide user input, via the input/output interface 160, for adjusting one or more parameters of the algorithm for producing the augmented reality display. Further, the input/output interface 160 may output an instruction or data received from the processor 120, the sensor interface 130, the memory 140, the input/output interface 160, the display 170, and/or the communication interface 180 to a different external device (e.g., electronic device 102, server 106, etc.).

The display 170 may include various types of displays, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 160 may display, for example, a variety of contents (e.g., text, image, video, icon, symbol, etc.) to the user. In an example, the display 170 may comprise an HMD (e.g., AR display) for displaying an augmented reality display of the object performing the sequence of actions along the animation path according to the one or more waypoints. As an example, the HMD may include an optical element that may selectably turn on or off a view of an outside environment in front of the user's eyes. The display 160 may include a touch screen. For example, the display 160 may receive a touch, gesture, proximity, or hovering input by using a stylus pen or a part of a user's body. As an example, the display 170 may output a user interface configured to output the AR display.

The communication interface 180 may establish, for example, communication between the computing device 101 and an external device (e.g., an electronic device 102 or one or more servers 106). For example, the communication interface 180 may communicate with the external device (e.g., the electronic device 102 or the one or more servers 106) by being connected to a network 162 through wireless communication or wired communication. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the network 162 may include at least one of a telecommunications network, a computer network (e.g., LAN or WAN), the internet, and a telephone network.

In addition, the communication interface 180 may communicate with the external device (e.g., the electronic device 102) via a communication connection 164 such as a wireless communication and/or wired communication. The wireless communication may include, for example, a near-distance communication 164. The near-distance communications 164 may include, for example, at least one of Wireless Fidelity (WiFi), Bluetooth, Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication may include, for example, at least one of Universal Serial Bus (USB), High Definition Multimedia Interface (HDMI), Recommended Standard-232 (RS-232), power-line communication, Plain Old Telephone Service (POTS), and the like.

The server 106 may include a group of one or more servers. In an example, all or some of the operations executed by the computing device 101 may be executed in a different one or a plurality of electronic devices (e.g., the electronic device 102 and/or the one or more servers 106). In an example, if the computing device 101 needs to perform a certain function or service either automatically or based on a request, the computing device 101 may request at least some parts of functions related thereto alternatively or additionally to a different electronic device (e.g., the electronic device 102 and/or the server 106) instead of executing the function or the service autonomously. The different electronic devices (e.g., the electronic device 102 and/or the server 106) may execute the requested function or additional function, and may deliver a result thereof to the computing device 101. In an example, the electronic device 102 may be configured to process the image data and the data indicative of the sequence of actions. For example, the electronic device 102 may receive the image data and the data indicative of the sequence of actions from the computing device 101 and/or the one or more servers 106, wherein the electronic device 102 may process the image data and the data indicative of the sequence of actions to generate the animation path and overlay of the object performing the sequence of actions according to the animation path and provide the animation path and overlay of the object performing the sequence of actions according to the animation path to the computing device 101 to be displayed via the display 170 (e.g., AR display). In an example, one or more of the servers 106 may be configured to process the image data and the data indicative of the sequence of actions. For example, one or more of the servers 106 may receive the image data and the data indicative of the sequence of actions from the computing device 101, wherein one or more of the servers 106 may process the image data and the data indicative of the sequence of actions to generate the animation path and overlay of the object performing the sequence of actions according to the animation path and provide the animation path and overlay of the object performing the sequence of actions according to the animation path to the computing device 101 to be displayed via the display 170 (e.g., AR display).

The system 100 in FIG. 1 provides a technical improvement over conventional augmented reality animation systems. Conventional systems suffer from computational inefficiency when processing large-scale outdoor environments, limited ability to generalize location compatibility prediction to new environments without extensive training data, and difficulty maintaining virtual character visibility as users move through outdoor spaces. The architecture described herein improves system operation by employing an adaptive octree structure that varies voxel resolution based on scene geometry density, thereby reducing memory requirements and processing time for path computation. In particular, the use of the few-shot learning model with the feature extractor enables the system 100 to predict location compatibility values for new outdoor environments with limited training data, while the modified A*algorithm that incorporates visibility cost, distance cost, and smoothness cost produces animation paths that maintain user visibility without requiring computationally expensive exhaustive search methods. As a result, the system 100 improves computational efficiency for large-scale outdoor environments, reduces the data collection burden for training location compatibility models, and enables real-time path recomputation in response to user movement that is not achievable in conventional augmented reality animation systems.

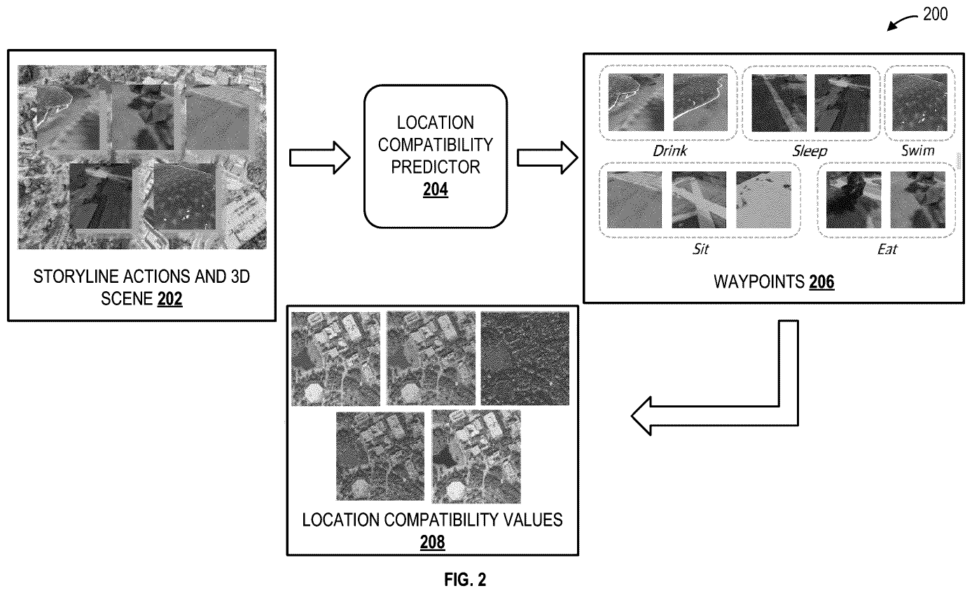

FIG. 2 shows an example process 200 for determining a location compatibility associated with an environment. The process may be implemented by a computing device (e.g., computing device 101, electronic device 102, one or more servers 106, or any combination thereof). As an example, an optimal animation path may be generated for a given storyline (e.g., sequence of storyline actions or sequence of actions) to be visualized in an environment in AR. The animation path may take a sequence of actions of an object's (e.g., virtual character, virtual object, etc.) storyline actions and a real-world 3D scene 202 associated with a user (e.g., three-dimensional (3D) representation of an environment within a user's viewpoint) as input. Based on the storyline actions and the 3D scene 202, a compatibility of each storyline action may be determined by a learning-based method (e.g., a location compatibility predictor 204). For example, the location compatibility predictor 204 may sample waypoints 206 where the object will perform its storyline actions (e.g., drink, sleep, swim, sit, eat, etc.), and synthesize a corresponding animation path via an optimization. For example, the location compatibility predictor 204 may be configured to determine location compatibility values 208 for performing different storyline actions on the input 3D scene.

The process 200 in FIG. 2 provides a technical improvement over conventional location classification approaches used in augmented reality systems. Conventional approaches require extensive labeled training data for each new environment and each storyline action class, resulting in significant data collection overhead and limited scalability to diverse outdoor settings. The location compatibility predictor 204 addresses this technical limitation by employing a few-shot learning architecture that extracts transferable visual features from the 3D scene and generalizes to new environments with minimal training examples. By determining location compatibility values based on learned correlations between scene geometry and storyline action suitability, the process 200 reduces the computational burden of exhaustive environment-specific training while enabling accurate waypoint sampling for semantically appropriate storyline action placement. As a result, the process 200 improves the efficiency of location compatibility prediction for large-scale outdoor environments and reduces the data requirements for deploying augmented reality animation experiences in previously unseen settings.

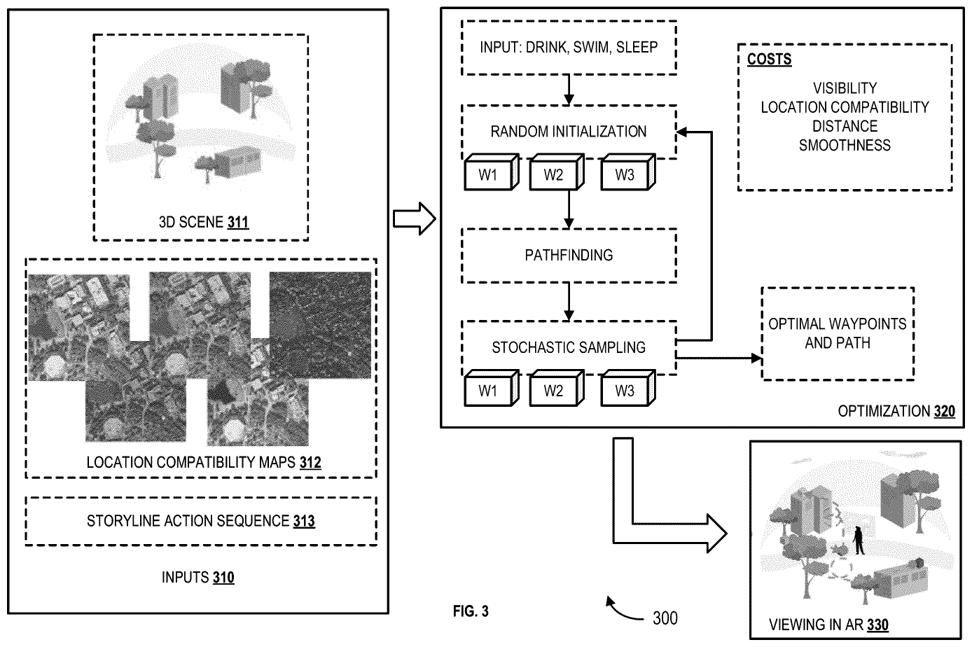

FIG. 3 shows an example process 300 for determining one or more waypoints in a three-dimensional (3D) environment (e.g., 3D scene) and generate an animation path for an object (e.g., virtual character, virtual object, etc.). The process may be implemented by a computing device (e.g., computing device 101, electronic device 102, one or more servers 106, or any combination thereof). As an example, a learning-based method (e.g., a location compatibility predictor, or the machine learning model 159) may synthesize an animation path for an object via an optimization 320 based on one or more inputs 310. For example, the one or more inputs may comprise a 3D scene 311, one or more location compatibility maps 312, and/or a sequence of storyline actions 313 (e.g., drink, sleep, swim, sit, eat, etc.). The 3D scene may be generated based on image data. In one example, image data of an environment within a viewpoint of a user may be captured by an image sensor (e.g., image sensor 130). In another example, image data may be retrieved via a location database (e.g., Google maps, Google earth, etc.) based on the user's location information (e.g., GPS information). The 3D scene may be generated based on the image data captured by the image sensor, the image data retrieved from the location data base, or a combination thereof.

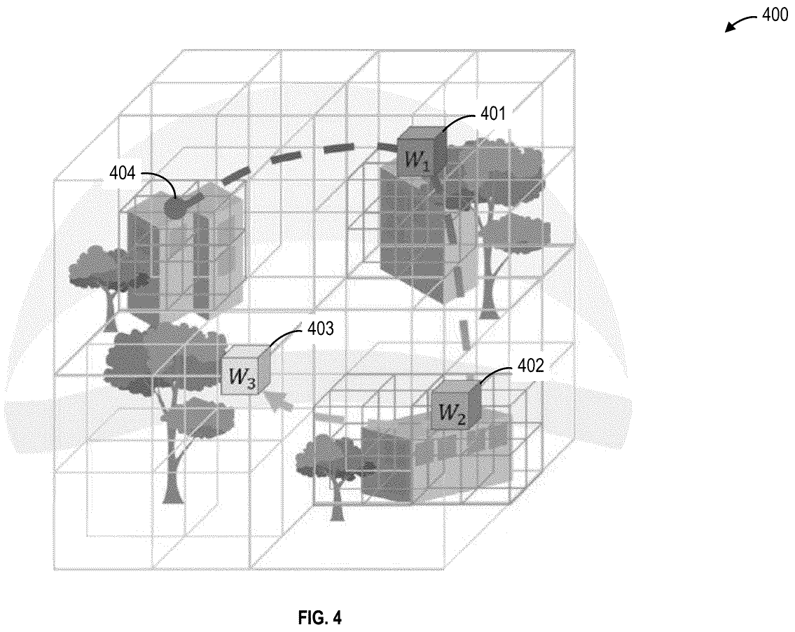

As shown in FIG. 4, the 3D scene 311 may be represented as a voxel set ‘V={V;} with an adaptive octree structure. The voxels within the voxel set refer to different levels of detail and vary in size depending on whether the enclosed 3D scene contains scene geometry. Each voxel may encode its location compatibility with respect to different storyline actions (e.g., inferred by a learning-based method such as via the location compatibility predictor, or the machine learning model 159). In addition, each voxel may encode visibility and distance information with respect to the user, wherein the user is assumed to be standing at a particular location and facing a particular direction in the 3D scene. In each iteration of the optimization 320, waypoints 401, 402, 403 ‘W={w;} may be sampled among centers of the voxels. The modified A* algorithm may be applied to the sampled waypoints 401, 402, 403 (e.g., voxel centers) to determine a connecting path (e.g., animation path starting at point 404 and ending at the last waypoint 403). As an example, the optimization 320 may consider the one or more location compatibility maps 312 and one or more costs. For example, the one or more costs may comprise a visibility of the sampled waypoints 401, 402, 403, as well as the visibility, distance from the user, and smoothness of the generated animation path.

A compatibility of one or more locations within the 3D scene 311 may be predicted (e.g., determined) for the object to perform the sequence of storyline actions 310. In an example, correlations between the geometry and functionality of 3D scenes 311 may be utilized to infer compatible storyline actions. In an example, the location compatibility predictor may be utilized to infer (e.g., determine) object storyline actions for large-scale 3D scenes. For example, the location compatibility predictor may comprise a learning-based method configured to determine probabilities that a specific location is compatible with various classes of storyline actions, such as A={drink, eat, sit, sleep, swim, etc.}.

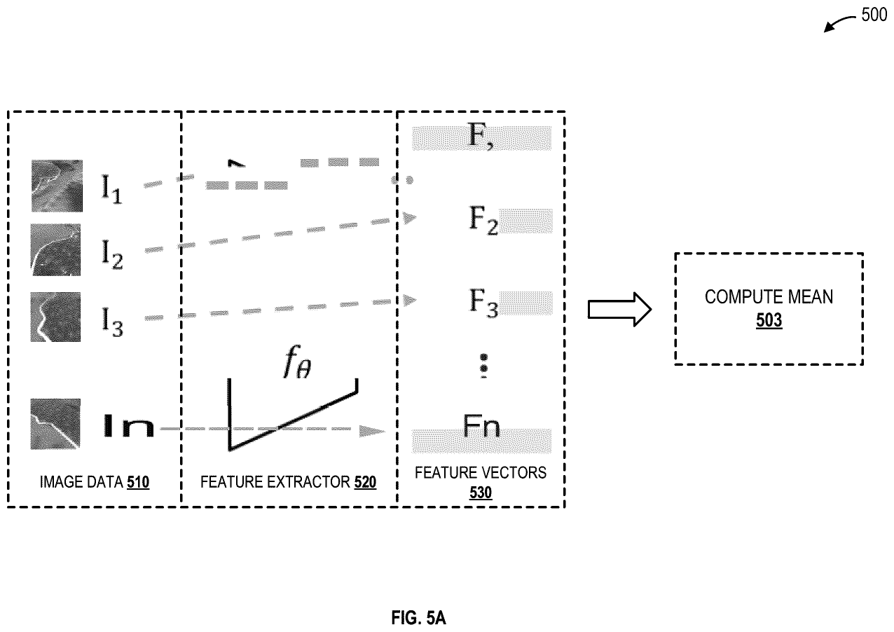

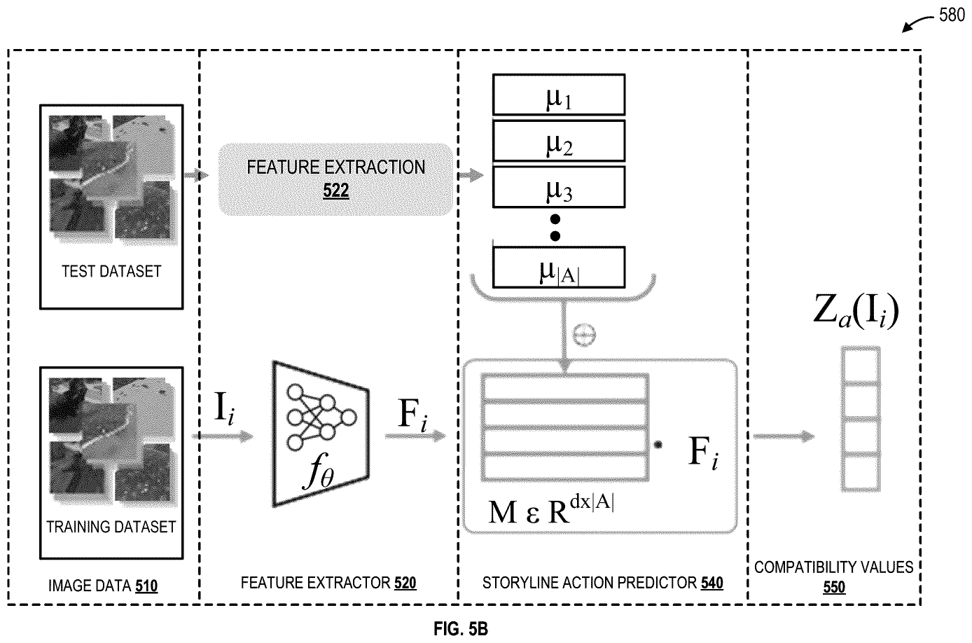

As an example, the location compatibility predictor may be configured based on, or may comprise, a few-shot learning method employing a feature extractor and a fine-tuned model. As shown in FIGS. 5A-5B a feature extractor 520 (e.g., pre-trained feature extractor) may be utilized to extract image features from image data 510, such as from the 3D scene. For example, as shown in FIG. 5A, one or more features may be extracted, wherein the feature extractor 520 may comprise a ResNet-18 configured to extract features from image data 510 in a dataset. For example, the feature extraction may be represented as:

$$μ = ; {L}_{l = 1} , f 0 ( J ; ) \qquad ( 1 )$$

For example, given an image I;, the feature extractor 520 may generate feature vector F;=f_{g}(I;) 530 and may determine a mean feature vector μ 503.|A| mean vectors 503 may be generated for each storyline action class based on using a training dataset comprising a plurality of location images. For example, |A| may comprise a total number of all available storyline action classes.

The learning-based method may be fine-tuned, as shown in FIG. 5B, based on initializing weights for the learning-based method. For example, a storyline action class A 540, and each class i having {μ;} (e.g., calculated form equation 1 above), may be utilized to determine an initial weight M={μ₁, μ₂, . . . , μ_{|A|}} based on a feature extraction 522 performed by the feature extractor 520, where M ∈R^{dx|A|} by concatenating all μ; and d is the length of the feature vector 530. The leaning-based method may be trained with weight M by fine-tuning the feature extractor f0 520 with the training dataset, which may be expressed as:

$${Z}_{a} ( J ; ) = \text{<} J ( M \cdot F ; ) \qquad ( 2 )$$

As an example, in equation 2, given an image I; from the training dataset, the feature F; may be extracted. The learning-based method may then measure the similarity between weight M and F; of input image I;. The sigmoid layer o″ may produce the compatibility value vector Zₐ(J;) 550 with respect to the storyline action class a∈A 540 for image I;.

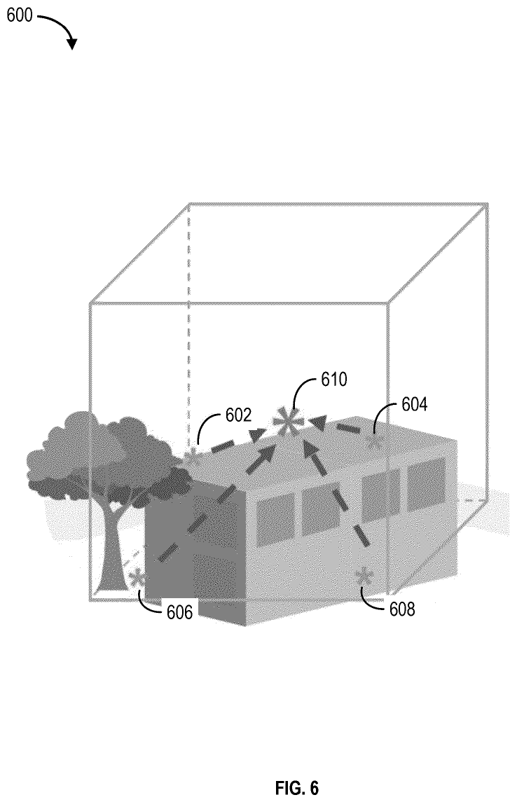

After the learning-based method is fine-tuned, the learning-based method may be configured to predict location compatibility values Za 550 with respect to storyline action class a ∈A on new image data. Location compatibility values 550 with respect to the storyline actions 540 may be determined for each voxel. As an example, the voxels in the grid may have varying sizes. For example, a large voxel may comprise multiple sampled locations of the 3D scene. For example, as shown in FIG. 6, a voxel may comprise a center 610 associated with sampled locations 602, 604, 606, 608 contained by the voxel. The location compatibility value 550 with respect to storyline action a 540 of a voxel v may be determined by averaging the location compatibility values 550 of the sampled locations contained by the voxel:

$${Z}_{a} ( v ) = L , {Z}_{a} ( J ) , \qquad ( 3 )$$

where a is the set of location images of all sampled locations contained by voxel V.

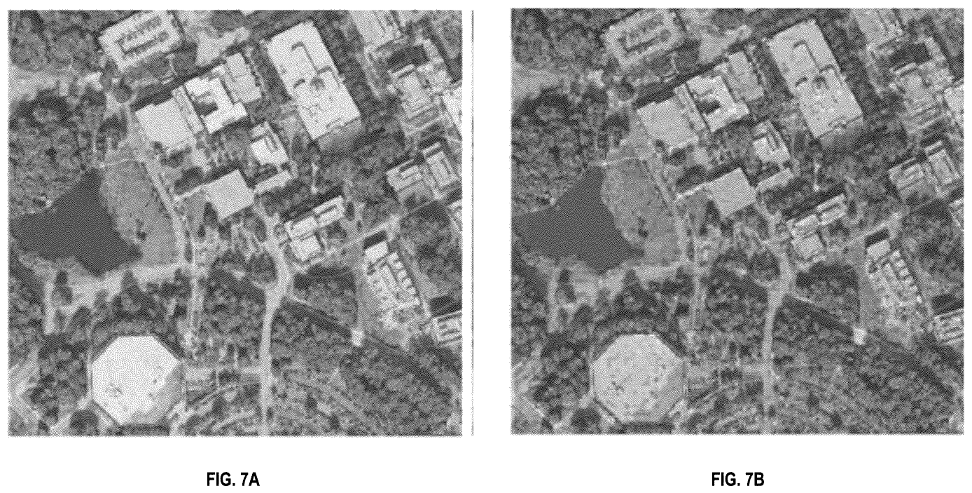

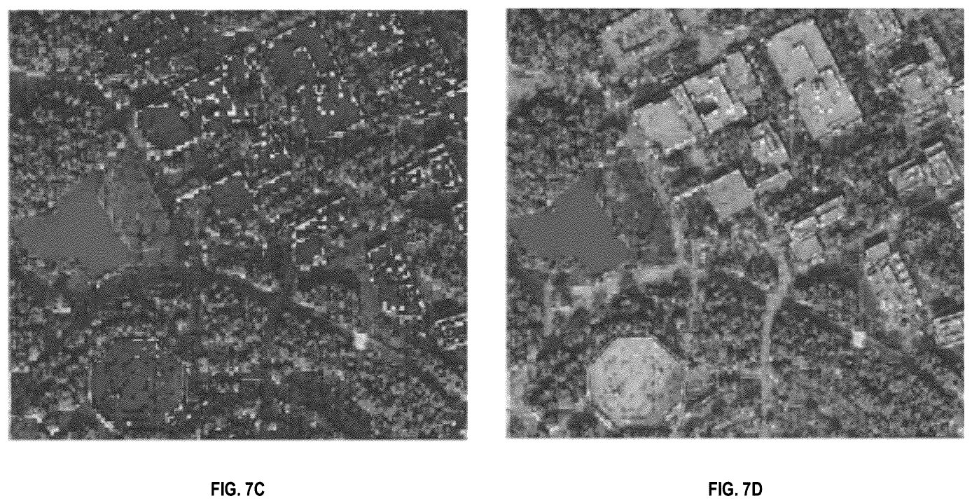

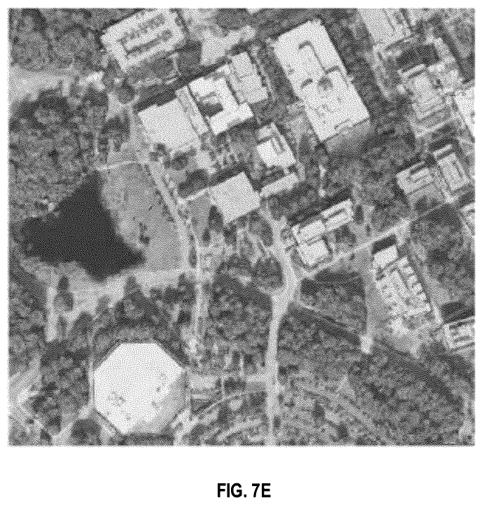

As shown in FIGS. 7A-7E, different location compatibility maps may be associated with different storyline actions, wherein each location compatibility map may consist of a grid of voxels overlaid in the 3D scene. Each voxel may be identified (e.g., highlighted according to a color) according to its location compatibility value for the storyline action class determined by equation 3. As shown in FIG. 7A a drink action may be compatible with locations around a lake shore. As shown in FIG. 7B, an eat action may be moderately compatible for particular locations on the location compatibility map. As shown in FIG. 7C a sit action may be highly compatible for particular locations on the location compatibility map. As shown in FIG. 7D a sleep action may be slightly more moderately compatible for particular locations on the location compatibility map. As shown in FIG. 7E, a swim action may be compatible with the lake.

Each of the waypoints may be sampled among the voxel centers, wherein the object may perform the storyline actions at each of the waypoints. For example, a sequence of waypoints ‘W={w₁, . . . , wₙ} for performing the sequence of storyline actions 51={a₁, . . . , aₙ}. Returning to FIG. 3, during the optimization 320, the waypoints may be updated, wherein the modified A* algorithm may determine a corresponding optimal path rp={v₁, . . . , vₙ}. In an example, a random initialization may be initialized, wherein a Markov chain Monte Carl (MCMC) sampler may be utilized to determine the optimal path.

As shown in FIG. 3, one or more costs may be utilized to determine the optimal path. For example, to evaluate solution T={(′W,P)}, a total cost function may be defined as:

$${C}_{total} ( T ) = {λ}_{way} {C}_{way} ( W ) + {λ}_{way} {C}_{way} ( P ) , \qquad ( 4 )$$

where ‘W={w₁ . . . wₙ} comprises a sequence of proposed waypoints. The total cost function may consist of two parts: waypoint cost C_{way} (′W) and path cost Cₚₐₜₕ (P). In an example, Cₚₐₜₕ (P) may change with C_{way} (′W) because rp depends on ‘W. For example, Cₚₐₜₕ (P) represents the cost of the current path determined by the current waypoints ‘W.

The waypoint costs C_{way} (′W) may comprise two cost terms: location compatibility cost C₁ and visibility cost Cᵥ with weights A_{J} and A_{vw}, which may be represented as:

$${C}_{way} {(}^{′} W ) = {I}_{i = 1}^{n} ( {A}_{1} {C}_{1} ( v ; , a ; ) + {A}_{vw} ( {C}_{v} ( v ; ) ) . \qquad ( 5 )$$

In equation 4, v; comprises the voxel at which waypoint w; is located in the current solution. The path cost Cₚₐₜₕ (P) is calculated using the generated path ‘P={vd} covering a series of voxels:

$${C}_{path} {(}^{′} P ) = {I}_{{VkE}^{′} P} ( {A}_{vp} {C}_{v} ( vk ) + {A}_{d} {C}_{d} ( {v}_{k} ) + {A}_{s} {C}_{s} ( {v}_{k} ) ) . \qquad ( 6 )$$

As an example, Cₚₐₜₕ (′P) may comprise three terms: visibility Cᵥ, distance C_{d}, and smoothness Cₛ with corresponding weights Aᵥₚ, A_{d}, Aₛ. In an example, the visibility cost may be employed twice with different weights, A_{vw} and Aᵥₚ, for evaluating the visibility of the waypoints in equation 5 and the visibility of the path in equation 6.

The location compatibility cost may be based on a compatibility of an action of the sequence of actions with a voxel of the 3D representation of the environment. For example, the location compatibility cost may be utilized to determine whether the waypoint w;'s voxel v; is compatible with the given storyline action a;, wherein the location compatibility cost may be represented as:

$$C 1 ( v ; , a ; ) = 1 - {Z}_{a} ; ( v ; ) , \qquad ( 7 )$$

where Zₐ; (v;) is a compatibility value of storyline action a; at voxel v; obtained from the location compatibility predictor. As an example, the cost prompts storyline action a; to occur at voxel v; with a high compatibility.

The visibility cost may be based on voxels of the 3D representation of the environment that are outside of a viewpoint of a camera capturing the environment and voxels of the 3D representation of the environment that are occluded by one or more of the characteristics of the environment. For example, the visibility cost may be utilized to check the visibility of the surrounding environment with respect to the user. The surrounding environment may be represented by a voxel grid, wherein the voxels may be visible with respect to the current position and head orientation of the user. Two culling processes may be applied, a frustum culling process and an occlusion culling process, to determine the visibility cost of each voxel. The frustum culling process may be implemented to exclude the voxels that are outside of the user's view frustum (e.g., an image sensor's, or an image capture device's, view frustum). For example, the image sensor (e.g., image sensor 130) pose may be set to the user's head pose. After the frustum culling process is implemented, the retained voxels may go through the occlusion culling process. For example, the occlusion culling process may be implemented to check whether the voxels are occluded by obstacles in the surrounding environment from the viewpoint of the user.

As an example, given a voxel v;, its visibility value CTᵥ; may be calculated (e.g., determined) by performing the occlusion culling process for all of its eight corners and the center. If a corner is visible, 1 is added to the visibility value CTᵥ;. If the center is visible, 8 is added to the visibility value CTᵥ; to account for the larger significance of the voxel center in representing the voxel's visibility. As such, each voxel v; may be associated with a visibility value CTᵥ; E[0, VₘₐₓL], where Vₘₐₓ=16. As an example, a voxel that is completely invisible has a visibility value of zero. For example, the visibility cost of each voxel v; may be defined as:

$$C 1 ( v ; ) = \frac{{V}_{max} - {CT}_{v ;}}{Vmax} . \qquad ( 8 )$$

The distance cost may be based on a distance between a position of a user and voxels of the 3D representation of the environment. For example, the distance cost may be implemented to generate a user-centered result. For example, the distance cost may be implemented to keep the generated animation path close to the user. For example, the distance cost may act as a regularization, determining a closer path when multiple path candidates have the same visibility. In an example, the distance cost may be a programmable term (e.g., by the user) in order to set different target distances. In and example, before the optimization 320 is initialized, the distances between the centers of all voxels and the user's position may be determined. As an example, it may be assumed that the area where the user can walk around is bounded in the real environment. As such, the maximum distance may be set as Dₘₐₓ in order to maintain a distance between the object and the user. In an example, Dₘₐₓ=250. The distance cost of a voxel Vₖ may be defined as:

$${C}_{d} ( {v}_{k} ) = \frac{{d}_{{v}_{k}}}{{D}_{max}} , \qquad ( 9 )$$

where dᵥₖ may comprise the distance between the user's position and the center of voxel Vₖ, and it is normalized by Dₘₐₓ.

The smoothness cost may be based on one or more angle changes between consecutive segments of the animation path. For example, the smoothness cost may be implemented to steer the modified A* algorithm to select the smoothest path possible, wherein the smoothness cost may be defined as:

$${θ}_{{v}_{k}} = {v}_{{v}_{k - 1} {v}_{k}} \cdot {v}_{{v}_{k} {v}_{k + 1}} , \qquad ( 10 )$$

$${C}_{s} ( {v}_{k} ) = \frac{1}{2} ( 1 - cos ( {0}_{{v}_{k}} ) ) .$$

As an example, the smoothness cost may be obtained during the runtime of the optimization 320 based on calculating an angle change θᵥₖ based on a previously selected voxel Vₖ₋₁, the current voxel vk, and the next candidate voxel Vₖ₊₁. As an example, without the smoothness cost, the optimization 320 may generate animation paths with sharp corners.

The optimization 320 may generate a set of optimized waypoints and connecting path in the voxel space. In an example, data indicative of the optimized waypoints and connecting path in the voxel space may be output for postprocessing, wherein the De Casteljau algorithm may be applied to composite multiple Bezier curves, whose end points may be the optimized waypoints, to obtain a smooth animation path. For example, the optimization 320 may apply a modified A* algorithm to find the optimal animation path for the object in the AR display considering the costs comprising visibility, distance from the user, and path smoothness. Due to its simplicity and robustness, the modified A* algorithm utilized for generating animation paths may utilize three costs: the visibility cost Cᵥ, the distance cost Cₐ, and the smoothness cost Cₛ. These costs may be implemented to estimate the animation path cost from the start voxel to the destination voxel by accumulating the cost associated with each voxel of the generated path, wherein i\vp,i\a and As are the weights of each cost. As an example, the weights may be set as 0.7, 0.2, and 0.1.

The modified A* algorithm may be implemented to identify/determine an animation path, starting from the waypoint where the object is located and ending at the final waypoint where the last storyline action takes place. For example, based on implementing the modified A* algorithm, a sequence of voxels comprising the optimized animation path may be determined. As an example, the optimized animation path may be generated for either a 3D animation path or a 2.5D animation path (e.g., along a ground or a wall depending on the voxels). For example, for generating an animation path for a humanoid character walking on the ground, a setting may be provided that cases the modified algorithm to ignore mid-air voxels and produce a 2.5D animation path.

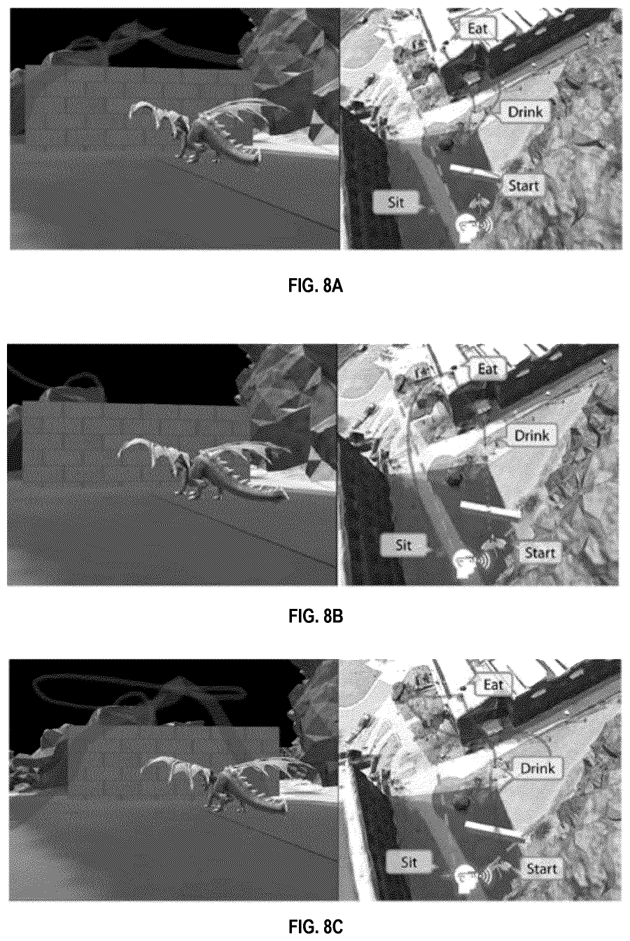

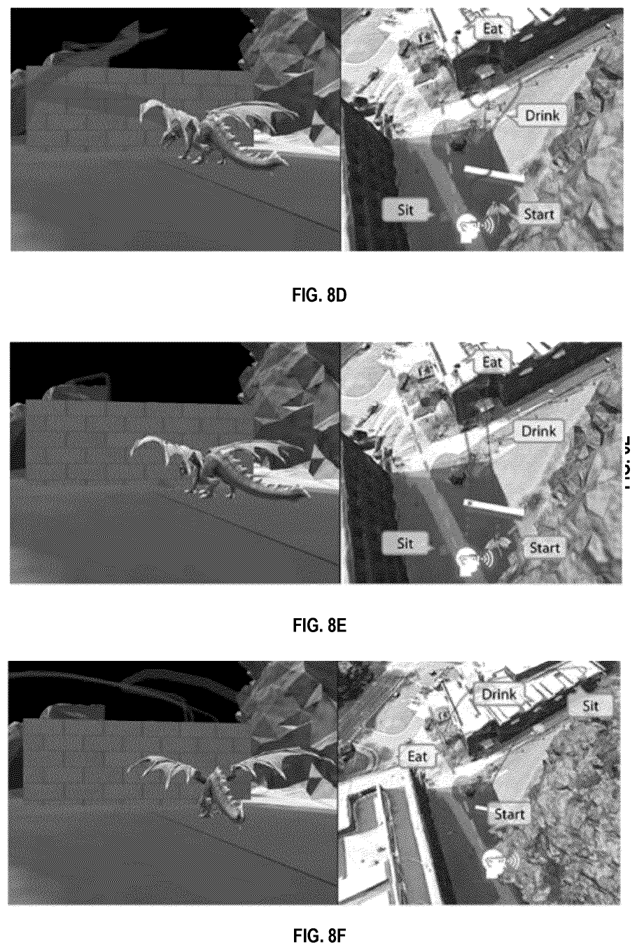

The modified A* algorithm may be implemented to determine term G, which may comprise a current path cost Cₚₐₜₕ (′Pg) and an estimated heuristic path cost Cₚₐₜₕ (′Pₕ):

$$G = {λ}_{g} {C}_{path} ( {P}_{g} ) + {λ}_{h} {C}_{path} ( {P}_{h} ) , \qquad ( 11 )$$

where ‘P_{g}={v₅, . . . , v;} from the start voxel Vₛ to the current voxel v; and ‘Ph= {v;, . . . , v_{d}} from the current voxel v; to the destination voxel v_{d}. As an example, the weights may be set as A_{g}=0.8 and Aₕ=0.2. The visibility cost Cᵥ may be implemented to determine visible voxels to approach a destination in the environment. For example, by reducing the value of the visibility cost, the modified A* algorithm selects a visible path through the user's surrounding environment. The distance cost Cₐ may be implemented to prompt the animation path to stay close to the user. The smoothness cost Cₛ may be implemented to favor a smooth path rather than a zig-zag path with sharp turns within the environment. For example, as shown in FIGS. 8A-8F, the waypoints and animation paths may be effected based on the use of the different costs. As shown in FIG. 8A, an animation path may be generated with all costs utilized. As shown in FIG. 8B, if the visibility cost is omitted, the object becomes less visible and more occluded (e.g., by a wall in the environment). As shown in FIG. 8C, if the distance cost is omitted, a long animation path may be generated that is far from the user. As shown in FIG. 8D, if the smoothness cost is omitted, a steep direction change may be generated after the start point of the animation path. As shown in FIG. 8E, if a traditional A* is implemented, a shortest path with no user-centered consideration may be generated. As shown in FIG. 8F, if the location compatibility cost is omitted, actions may be performed at incompatible locations.

During the optimization 320, a simulated annealing may be applied in order to find the optimal animation path that satisfies one or more optimization criteria. For example, a Boltzmann-like objective function may be defined as:

$$f ( T ) = {e}^{\frac{1}{τ} {C}_{total} ( T )} , \qquad ( 12 )$$

where r may comprise a temperature parameter of simulated annealing. The temperature may be decreased gradually over the optimization 320 iterations. As an example, the lower the temperature, the greedier the optimization 320. The optimization 320 may be terminated when the total cost change converges to less than 3%. In an example, A_{way}=50, Aₚₐₜₕ=1, A_{J}=0.9, A_{vw}=0.1, Aᵥₚ=0.7, A_{d}=0.2, and Aₛ=0.1. In an example, the lambda values may be adjusted according to characteristics (e.g., spaciousness) of a scene.

In an example, in order to determine possible waypoint locations, the optimization 320 may be configured to determine a local move that translates a randomly-selected waypoint within a certain range slightly and randomly. This range may reduce with the temperature decrease until reaching 20% of the original range. In an example, the optimization 320 may apply a global reconfiguration move occasionally that swaps two randomly-selected waypoints. The selection probabilities of the local move and global move may comprise 90% and 10%, respectively. The solution output by the optimization 320 may be determined by applying a move that is accepted with a probability set by the Metropolis criterion. The optimal waypoints and animation path may be output for display via an augmented reality display 330.

The process 300 in FIG. 3 provides a technical improvement over conventional animation path generation systems used in augmented reality applications. Conventional systems generate paths based solely on geometric constraints without considering the semantic compatibility between virtual character actions and environmental features, resulting in visually incongruous augmented reality experiences where characters perform actions at inappropriate locations. The process 300 addresses this technical limitation by jointly optimizing waypoint selection based on location compatibility values and path synthesis based on visibility, distance, and smoothness costs. By integrating the location compatibility maps 312 with the optimization 320 that considers user-centered factors, the process 300 enables the generation of animation paths where storyline actions are performed at semantically appropriate locations while maintaining visibility from the user's perspective. The stochastic sampling approach combined with simulated annealing enables efficient exploration of the solution space without requiring exhaustive enumeration of all possible waypoint and path combinations, thereby reducing computational overhead while producing high-quality animation paths that adapt to diverse outdoor environments.

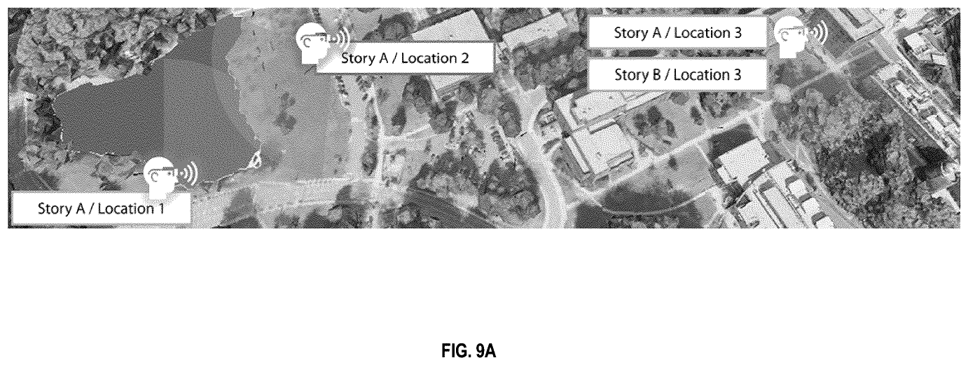

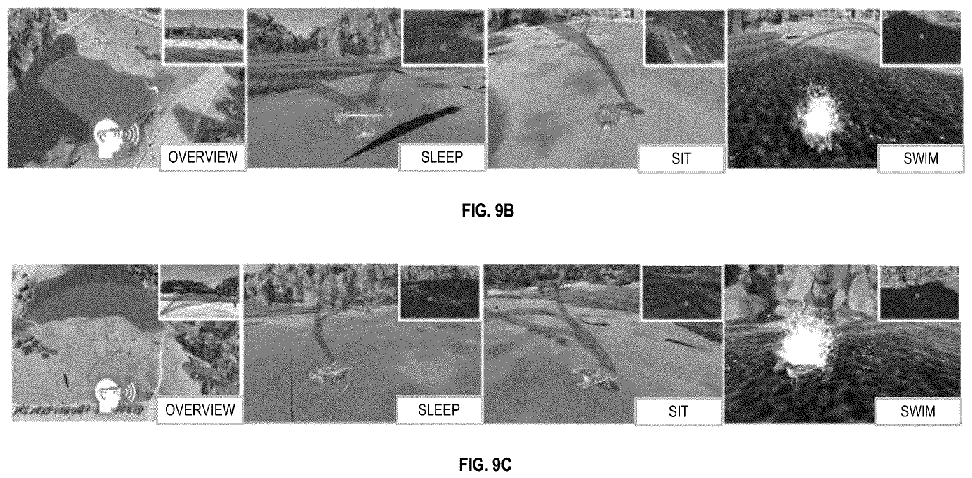

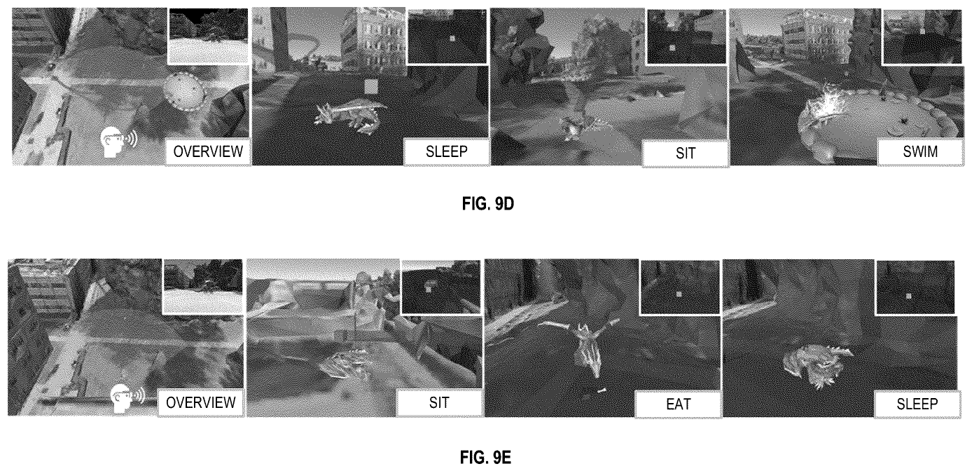

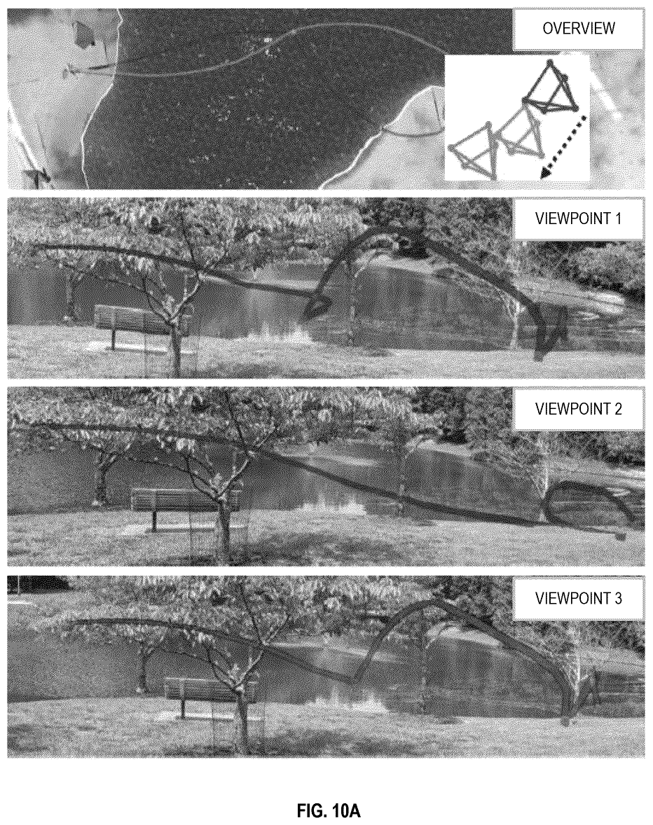

FIGS. 9A-9E show example animation paths associated with different locations. For example, FIG. 9A shows an overview of different sequences of storyline actions associated with different locations. For example, a first sequence of storyline actions may be associated with a first location (e.g., as shown in FIG. 9B), a second location (e.g., as shown in FIG. 9C), and a third location (e.g., as shown in FIG. 9D), while a second sequence of storyline actions may be associated with the third location (e.g., as shown in FIG. 9E). The waypoints may be determined according to their associated storyline actions and their compatibility with contexts of the environment. For example, based on location compatibility maps, storyline actions (e.g., sleep, sit, eat, swim, etc.) may be placed at locations with high compatibility values of the commensurate actions. For example, for an object comprising a dragon, the dragon swims in a lake or a virtual fountain. In an example, the generated animation paths may be fully visible from the user's locations.

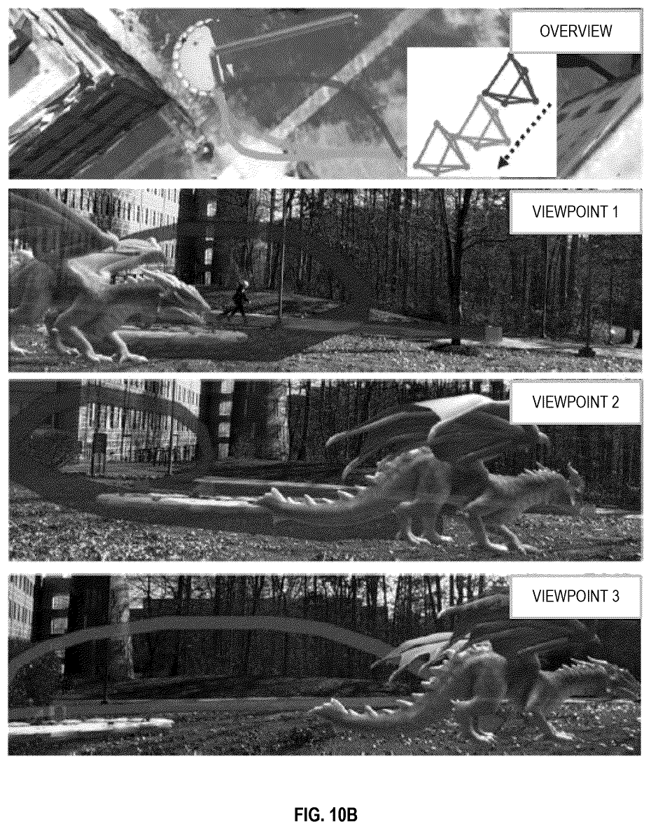

FIGS. 10A-10B show an example environment for overlaying an object performing a sequence of storyline actions. In one example, as shown in FIG. 10A, the environment may comprise a lake. In another example, as shown in FIG. 10B, the environment may comprise a campus. For example, as shown in FIGS. 10A-10B, as a user walks from a first location to a second location, the animation path may be updated, in real-time, so that an object (e.g., virtual character, virtual object, etc.) stays visible to the user. As an example, a frequency of updates may depend on the user's distance traveled. For example, the animation path may be updated every time the user moves a predetermined distance from the user's previous location, while determining the visibility based on the orientation of the user's viewpoint.

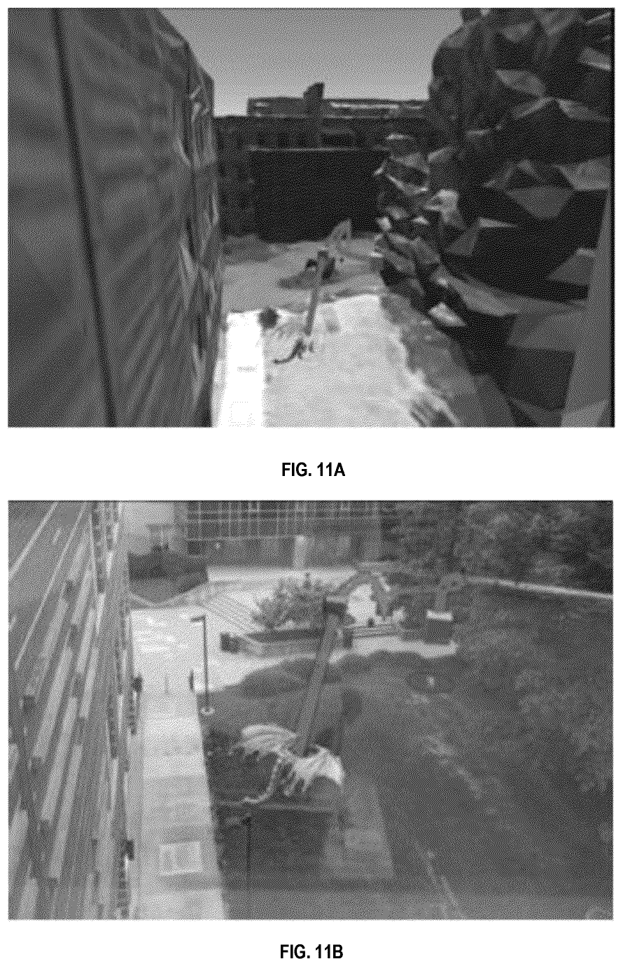

FIGS. 11A-11B show examples of user viewpoints of an environment. For example, as shown in FIGS. 11A-11B, the user may be looking outside of a window from a building.

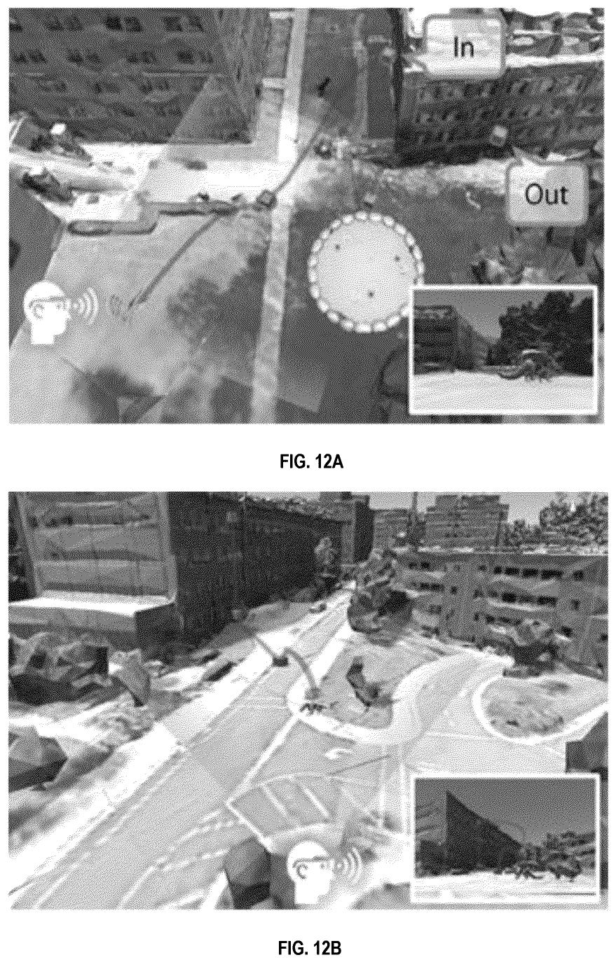

FIGS. 12A-12B show examples of animation paths generated based on waypoint constraints. For example, as shown in FIG. 12A, two waypoints may be set at two windows to guide an object (e.g., a virtual character such as a dragon) through a building. For example, as shown in FIG. 12B, two points may be set on a wall to guide the object (e.g., a dragon) to fly along the wall.

The animation paths, environments, and user viewpoints shown in FIGS. 9A-12B provide a technical improvement over conventional augmented reality animation systems that fail to adapt virtual character trajectories based on environmental semantics and user perspective changes. Conventional systems generate static animation paths that do not account for the semantic compatibility between storyline actions and environmental features, resulting in virtual characters performing actions at visually inappropriate locations such as swimming on land or sleeping in water. The technical solution shown in FIGS. 9A-9E addresses this limitation by determining waypoints based on location compatibility values that correlate storyline actions with semantically appropriate environmental regions, ensuring that actions such as swimming occur at bodies of water and sleeping occurs at shaded areas. Furthermore, conventional systems suffer from visibility degradation as users move through outdoor environments, causing virtual characters to become occluded or exit the user's field of view. The real-time path updating mechanism shown in FIGS. 10A-10B addresses this technical problem by recomputing animation paths in response to user movement, maintaining virtual character visibility throughout the augmented reality experience. The waypoint constraint functionality shown in FIGS. 12A-12B provides additional technical capability by enabling animation paths to be guided through specific architectural features such as windows and along walls, which conventional pathfinding algorithms cannot accommodate without extensive manual configuration.

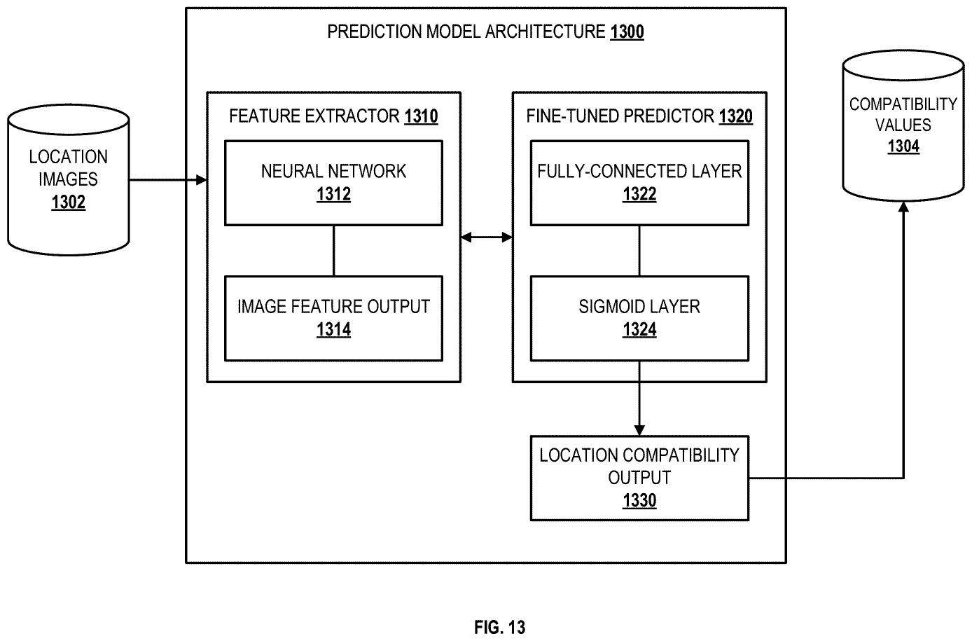

FIG. 13 shows an example prediction model architecture 1300 configured to implement a location compatibility predictor. The prediction model architecture 1300 may comprise a feature extractor 1310, a fine-tuned predictor 1320, and a location compatibility output 1330 that operate in sequence to determine one or more compatibility values 1304 based on image data 1302. For example, the feature extractor 1310 may receive the image data 1302. The image data 1302 may comprise three-dimensional (3D) representations of an environment. For example, the image data 1302 may be rendered from voxel positions within the adaptive octree structure or captured directly by an image capture device (e.g., imaging sensor 130). Each image of the image data 1302 may depict a view of the environment from a viewpoint of a user, providing visual context that the prediction model architecture 1300 may analyze to determine suitability for storyline actions of an object (e.g., virtual character, virtual object, etc.).

The feature extractor 1310 may comprise a neural network 1312 that performs convolutional operations on the image data 1302 to extract image features. The neural network 1312 may comprise a ResNet-18 neural network architecture without a last fully-connected layer, wherein the neural network 1312 may be pre-trained based on a large-scale image classification dataset to learn general visual representations. The neural network 1312 may process each image of the image data 1302 through a series of convolutional layers, batch normalization layers, and activation functions to produce high-dimensional feature representations that encode semantic and structural information of the corresponding environment captured in each image. The neural network 1312 may generate an image feature output 1314. The image feature output 1314 may comprise a feature vector representing extracted visual characteristics of the image data 1302. In an example, the image feature output 1314 may comprise a 512-dimensional feature vector when using a ResNet-18 architecture.

The image feature output 1314 may be provided to the fine-tuned predictor 1320, wherein the fine-tuned predictor 1320 may transform the extracted features into location compatibility predictions. The fine-tuned predictor 1320 may comprise a fully-connected layer 1322 that receives the image feature output 1314 and performs a linear transformation to map the feature representation to a prediction space corresponding to a plurality of storyline action classes (e.g., drink, eat, sit, sleep, swim, etc.). The fully-connected layer 1322 may comprise learnable weight parameters that have been initialized using computed mean feature vectors for each storyline action class of the plurality of storyline action classes. The fully-connected layer 1322 may be subsequently fine-tuned using training data. As an example, the weight initialization using mean feature vectors may enable the prediction model architecture 1300 to operate as a few-shot learning model, generalizing to new environments with limited training examples.

The fully-connected layer 1322 may be connected to a sigmoid layer 1324. For example, the sigmoid layer 1324 may apply a sigmoid activation function to the output of the fully-connected layer 1322. The sigmoid layer 1324 may transform the outputs (e.g., linear outputs) into probability values bounded between zero and one, wherein each probability value indicates the compatibility of the input location for performing a respective storyline action. As an example, the sigmoid layer 1324 may enable multi-labeled predictions, allowing a single location to be identified as compatible with multiple storyline actions simultaneously. For example, a location near a body of water may receive high compatibility values for both swimming and drinking actions.

The sigmoid layer 1324 may provide the probability values to the location compatibility output 1330. As an example, the location compatibility output may comprise final compatibility predictions generated by the prediction model architecture 1300. The location compatibility output 1330 may generate compatibility values 1304 for each of the plurality of storyline action classes (e.g., drink, eat, sit, sleep, swim, etc.). Each compatibility value 1304 may indicate a suitability of the corresponding location within the 3D representation for performing the respective character action. The compatibility values 1304 may be utilized to identify appropriate locations for the object to perform storyline actions.

As an example, the prediction model architecture 1300 may be trained based on extracting feature vectors from a plurality of location images of a plurality of environments using the feature extractor 1310, computing mean feature vectors for each of a plurality of storyline action classes based on the extracted feature vectors, initializing weights of the fully-connected layer 1322 using the computed mean feature vectors, and fine-tuning the prediction model architecture 1300 using training data comprising the plurality of location images with associated ground truth compatibility labels. The few-shot learning approach employed by the prediction model architecture 1300 may reduce the data collection burden compared to conventional deep learning approaches that require large annotated datasets for each new environment.

The prediction model architecture 1300 illustrated in FIG. 13 provides a technical improvement over conventional location classification systems by employing a few-shot learning architecture that generalizes to new outdoor environments with limited training data. Conventional systems require extensive data collection and model retraining for each new environment, resulting in significant computational overhead and deployment delays. The prediction model architecture 1300 addresses this technical limitation by leveraging a pre-trained neural network to extract transferable visual features and initializing a fully-connected layer with mean feature vectors computed from a small number of exemplar images. This architectural arrangement enables the system to predict location compatibility values for previously unseen environments without requiring environment-specific training data, thereby reducing memory requirements for storing training datasets, decreasing processing time for model adaptation, and enabling rapid deployment of augmented reality animation experiences in diverse outdoor settings. The technical improvement is rooted in the specific arrangement of the feature extractor and the fine-tuned predictor, which together implement a computationally efficient inference pipeline.

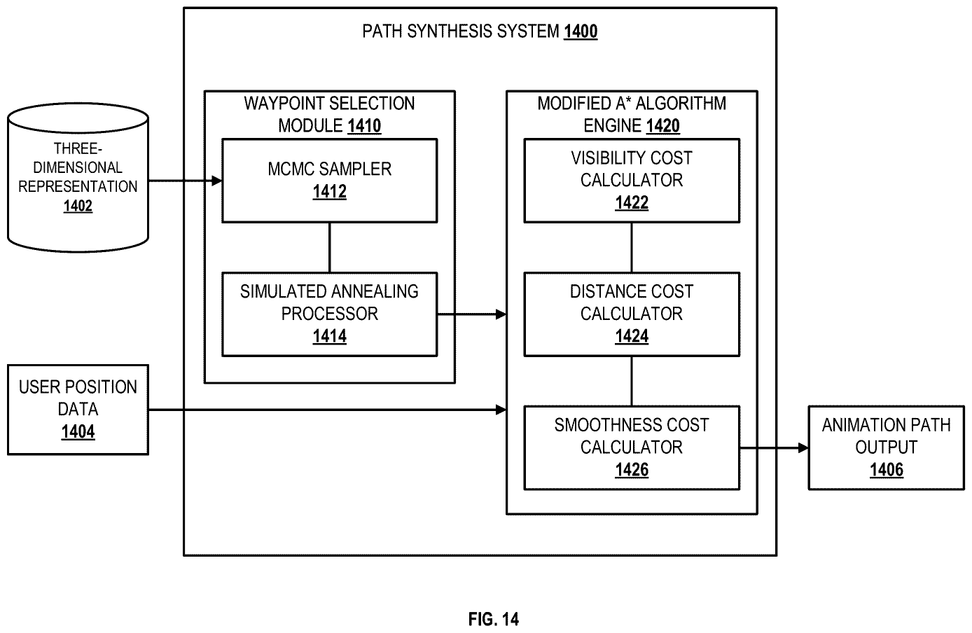

FIG. 14 shows an example path synthesis system 1400 configured to generate an animation path for an object. The path synthesis system 1400 may comprise a waypoint selection module 1410 and a modified A* algorithm engine 1420 that operate in coordination to generate optimized animation paths for objects (e.g., virtual characters, virtual objects, etc.) in an augmented reality display, or augmented reality environments. The path synthesis system 1400 may receive a three-dimensional (3D) representation 1402 of an environment and user position data 1404 and may generate an animation path output 1406 connecting one or more waypoints of the 3D representation 1402. For example, the animation path output 1406 may define a trajectory along which an object will be rendered.

The waypoint selection module 1410 may be configured to identify optimal locations within the 3D representation 1402 where the object will perform a sequence of storyline actions. The waypoint selection module 1410 may receive the 3D representation 1402. For example, the path synthesis system 1400 may be implemented by a computing device (e.g., computing device 101). The computing device may generate the 3D representation 1402 based on image data of an environment within a viewpoint of a user. In one example, the computing device may comprise an image sensor (e.g., image sensor 130), wherein the computing device may capture the image data via the image sensor. In another example, the computing device may retrieve the image data from a location database (e.g., Google maps, Google earth, etc.) based on the user's location (e.g., GPS information). The 3D representation 1402 may comprise a voxel set with an adaptive octree structure representing a real-world environment. The waypoint selection module 1410 may determine compatibility values (e.g., compatibility values 1304 generated by the prediction model architecture 1300) to determine one or more locations within the 3D representation 1402 that are suitable for each storyline action in the sequence of storyline actions to be performed by the object.

The waypoint selection module 1410 may comprise a Markov chain Monte Carlo (MCMC) sampler 1412 that may be configured to implement an MCMC sampling algorithm to search for optimal waypoint configurations. The MCMC sampler 1412 may maintain a current configuration of waypoints. The MCMC sampler 1412 may be configured to iteratively propose modifications to the current configuration of waypoints, wherein the MCMC sampler 1412 may accept or reject proposed modifications based on an energy function that evaluates the quality of the waypoint configuration. The MCMC sampler 1412 may operate on the discrete space of candidate waypoint locations identified from the compatibility values, analyzing different combinations of waypoints to identify configurations that satisfy storyline requirements while optimizing for animation path quality metrics.

The waypoint selection module 1410 may further comprise a simulated annealing processor 1414, wherein the MCMC sampler 1412 may be connected to the simulated annealing processor 1414. The simulated annealing processor 1414 may be configured to control an acceptance probability for proposed waypoint modifications during the sampling process. The simulated annealing processor 1414 may implement a temperature schedule that begins with a high temperature allowing exploration of diverse waypoint configurations and gradually decreases in temperature to converge toward optimal solutions. As such, the simulated annealing processor 1414 enables the waypoint selection module 1410 to escape local minima in the energy landscape by probabilistically accepting configurations that temporarily increase the energy function value when the temperature is high.

The simulated annealing processor 1414 may be configured to coordinate two types of proposal moves executed by the MCMC sampler 1412. In one example, local moves may translate a randomly-selected waypoint within a predefined range, shifting the waypoint to a nearby location while maintaining the overall structure of the waypoint configuration. In another example, global reconfiguration moves may swap two randomly-selected waypoints, exchanging locations assigned to different storyline actions to explore fundamentally different animation path configurations. As an example, the combination of local and global moves may enable the waypoint selection module 1410 to efficiently search the solution space without requiring exhaustive enumeration of all possible waypoint combinations.

The waypoint selection module 1410 may output selected waypoints to the modified A* algorithm engine 1402. The modified A* algorithm engine 1402 may be configured to synthesize an animation path connecting the selected waypoints. For example, the modified A* algorithm engine 1402 may be configured to implement a graph search algorithm that finds paths through the voxel-based 3D representation 1402 while optimizing a multi-objective cost function. The modified A* algorithm engine 1402 may maintain an open set of voxels to be evaluated and a closed set of voxels that have been processed, wherein the modified A* algorithm engine 1402 may iteratively expand the search frontier toward the goal waypoints.

The modified A* algorithm engine 1402 may comprise a visibility cost calculator 1422, a distance cost calculator 1424, and a smoothness cost calculator 1426. The visibility cost calculator 1422 may be configured to evaluate the visibility of voxels along potential path segments with respect to the user perspective. For example, the visibility cost calculator 1422 may receive user position data 1404, wherein the user position data 1404 may comprise a current position and viewing direction of a user within the real-world environment. The visibility cost calculator 1422 may be configured to perform occlusion testing for each candidate voxel by casting rays from the user position to corners and a center of the voxel in order to determine whether scene geometry within the 3D representation 1402 obstructs the line of sight between the user and the voxel. The visibility cost calculator 1422 may also be configured to perform frustum culling in order to determine whether voxels fall within the user's field of view based on the user viewing direction. Voxels that are occluded or outside the viewing frustum may receive higher visibility cost values, biasing the path synthesis toward trajectories that remain visible to the user.

The visibility cost calculator 1422 may be connected to the distance cost calculator 1424. The distance cost calculator 1424 may be configured to evaluate the distance between candidate voxels and the user position. For example, the distance cost calculator 1424 may receive the user position data 1404 and compute (e.g., determine) Euclidean distances from each candidate voxel to the user position. The distance cost calculator 1424 may assign higher cost values to voxels that are excessively far from the user, where the object would appear too small to be clearly perceived, and to voxels that are excessively close to the user, where the object might appear unnaturally large or intrusive. The distance cost calculator 1424 may be configured to implement a cost function that favors voxels within an optimal viewing distance range, ensuring that the object remains at an appropriate scale relative to the user's perspective throughout the animation.

The distance cost calculator 1424 may be connected to the smoothness cost calculator 1426. The smoothness cost calculator 1426 may be configured to evaluate the geometric smoothness of animation path segments. For example, the smoothness cost calculator 1426 may compute (e.g., determine) angle changes between consecutive path segments, assigning higher cost values to paths that require sharp turns or abrupt direction changes. As such, the smoothness cost calculator 1426 promotes animation paths that follow natural, flowing trajectories consistent with realistic character movement. The smoothness cost calculator 1426 may evaluate the angle between the vector from a previous voxel to a current voxel and the vector from the current voxel to a next voxel, penalizing configurations where these vectors form acute angles.

The modified A* algorithm engine 1420 may then accumulate the visibility cost, the distance cost, and the smoothness cost for each voxel along candidate animation paths in order to compute (e.g., determine) a total animation path cost that guides the search toward optimal solutions. The modified A* algorithm engine 1420 may implement a heuristic function that estimates the remaining cost to reach goal waypoints, enabling efficient pruning of suboptimal path branches. As an example, the modified A* algorithm engine 1420 may process voxels in order of their estimated total cost, expanding the most promising paths first to reduce computational overhead.

The modified A* algorithm engine 1420 may generate an animation path output 1406. For example, the animation path output 1406 may specify a sequence of voxels through which the object will travel (e.g., perform a sequence of storyline actions). For example, the animation path output 1406 may comprise the selected waypoints where storyline actions will be performed and the connecting animation path segments that transition the object between waypoints. The animation path output 1406 may be output to a display (e.g., a head mounted display such as an augmented reality display) for rendering the object along the computed animation path via the display.

In an example, the path synthesis system 1400 may support real-time path recomputation in response to changes in user position or orientation. For example, when the user position data 1404 indicates that the user has moved or changed viewing direction, the modified A* algorithm engine 1420 may reevaluate the visibility cost and distance cost for voxels along the current animation path. If the cost evaluation indicates that portions of the path have become suboptimal due to user movement, the modified A* algorithm engine 1420 may resynthesize affected animation path segments to maintain visibility and appropriate viewing distance. The path synthesis system 1400 may also trigger the waypoint selection module 1412 to reevaluate waypoint configurations when user movement significantly changes the relative positions of the user and candidate waypoint locations.

The path synthesis system 1400 illustrated in FIG. 14 provides a technical improvement over conventional pathfinding systems used in augmented reality applications. Conventional pathfinding systems compute paths based solely on geometric constraints such as obstacle avoidance and path length minimization, without accounting for user-oriented factors that are critical for augmented reality experiences. These conventional systems produce paths that may become occluded as users move through outdoor environments, resulting in virtual characters that disappear from view and disrupt the continuity of augmented reality storytelling experiences. The path synthesis system 1400 addresses this technical limitation by incorporating a visibility cost calculator, a distance cost calculator, and a smoothness cost calculator into a modified A algorithm engine, enabling path synthesis that jointly optimizes for geometric feasibility and user visibility. The path synthesis system 1400 further incorporates the use of a waypoint selection module to efficiently search the combinatorial space of waypoint configurations without requiring exhaustive enumeration. This architectural arrangement enables the path synthesis system 1400 to generate animation paths that maintain virtual character visibility as users move through large-scale outdoor environments, reduces computational overhead compared to exhaustive search methods, and supports real-time path recomputation that is necessary for responsive augmented reality experiences.

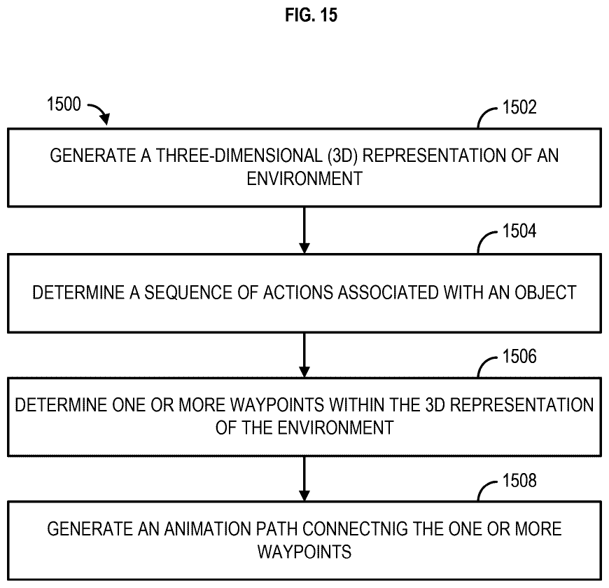

FIG. 15 shows a flowchart of example method 1500 for generating an animation path for a virtual character in an augmented reality environment. Method 1500 may be implemented by a computing device (e.g., computing device 101, electronic device 102, one or more servers 106, or any combination thereof). At step 1502, a three-dimensional (3D) representation of an environment may be generated. For example, a computing device (e.g., computing device 101, electronic device 102, one or more servers 106, etc.) may generate the 3D representation of the environment based on image data of an environment. As one example, the 3D representation of the environment may be generated from image data captured by an image sensor (e.g., image sensor 130). In an example, location information (e.g., GPS information) and a location database (e.g., Google maps, Google earth, etc.) may be accessed in order to retrieve image data, via the location database. As another example, the 3D representation of the environment may be generated based on the image data retrieved from the location database. As another example, the 3D representation of the environment based on a combination of the image data captured by the image sensor and the image data retrieved from the location database. The environment may comprise one or more characteristics. The one or more characteristics may comprise one or more of one or more objects, one or more buildings, one or more roads, one or more terrain features, and the like. The one or more terrain features may comprise one or more of one or more bodies of water, one or more hills, one or more plants, one or more mountains, and the like.

At step 1504, a sequence of actions associated with an object may be determined. For example, the computing device (e.g., computing device 101, electronic device 102, one or more servers 106, etc.) may determine the sequence of actions associated with the object for insertion in an augmented reality display. In an example, a plurality of sequences of actions associated with the object may be determined. For example, the plurality of sequences of actions may be stored (e.g., as a data file) on the computing device or may be stored in an external device (e.g., on a server such as server 106). The plurality of sequences of actions may be retrieved, and a machine learning may be implemented to select the sequence of actions from the plurality of sequences of actions based on the plurality of sequences of actions and the data indicative of the 3D representation of the environment. For example, the sequence of actions may be selected from the plurality of sequences of actions based on a compatibility of the sequence of actions with one or more locations within the 3D representation of the environment. The object may comprise a virtual character or a virtual object.

At step 1506, one or more waypoints may be determined within the 3D representation of the environment. For example, the computing device (e.g., computing device 101, electronic device 102, one or more servers 106, etc.) may implement the machine learning model to determine the one or more waypoints within the 3D representation of the environment for the object to perform the sequence of actions based on data indicative of the 3D representation of the environment and data indicative of the sequence of actions associated with the object. For example, the machine learning model may be implemented to determine one or more compatibility values associated with one or more locations within the 3D representation of the environment based on the data indicative of the 3D representation of the environment and the data indicative of the sequence of actions associated with the object. The one or more waypoints within the 3D representation of the environment for the object to perform the sequence of actions may be determined based on the one or more compatibility values.

At step 1508, an animation path connecting the one or more waypoints may be generated. For example, the computing device (e.g., computing device 101, electronic device 102, one or more servers 106, etc.) may generate the animation path connecting the one or more waypoints. As an example, the object may perform the sequence of actions in the augmented reality display along the animation path according to the one or more waypoints. In an example, the animation path connecting the one or more waypoints may be generated based on one or more of a location compatibility cost, a visibility cost, a distance cost, or a smoothness cost. The location compatibility cost may be based on a compatibility of an action of the sequence of actions with a voxel of the 3D representation of the environment. The visibility cost may be based on voxels of the 3D representation of the environment that are outside of a viewpoint of a camera capturing the environment and voxels of the 3D representation of the environment that are occluded by one or more characteristics of the environment. The distance cost may be based on a distance between a position of a user and voxels of the 3D representation of the environment. The smoothness cost may be based on one or more angle changes between consecutive segments of the animation path.

In an example, an overlay of the object performing the sequence of actions according to the animation path may be generated. The computing device may display the overlay of the object performing the sequence of actions according to the animation path within a viewpoint of a user of the augmented reality display via the augmented reality display (e.g., display 170). As an example, the user, wearing an AR headset, may watch the object animated via the synthesized animation path, performing the sequence of storyline actions at semantically compatible places within the user's surroundings in the real world.

In an example, one or more of a change in a position of the user of the computing device or a change in a viewpoint of the user may be determined. The animation path may be updated based on one or more of the change in the position of the user or the change in the viewpoint of the user. For example, the generated animation paths may be adapted to the user and the environment in order to deliver immersive augmented reality experiences.

The method 1500 illustrated in FIG. 15 provides a technical improvement over conventional animation path generation methods used in augmented reality systems. Conventional methods generate animation paths based on predetermined trajectories or simple geometric constraints without considering the semantic relationship between virtual character actions and environmental features, resulting in virtual characters that perform actions at visually inappropriate locations within the augmented reality display. The method 1500 addresses this technical limitation by determining one or more waypoints based on compatibility values that correlate the sequence of actions with locations within the 3D representation of the environment, ensuring that each action in the sequence is performed at a semantically appropriate location. Furthermore, conventional methods fail to account for user-centered factors during path generation, producing animation paths that may become occluded or exit the user's field of view as the user moves through the environment. The method 1500 addresses this technical problem by generating the animation path based on a visibility cost, a distance cost, and a smoothness cost in addition to the location compatibility cost, enabling the synthesis of animation paths that maintain visibility from the user's perspective while following natural trajectories. The technical improvement is rooted in the specific sequence of operations that jointly optimize waypoint selection and path synthesis based on both environmental semantics and user-oriented factors, reducing computational overhead compared to exhaustive search methods while producing animation paths that adapt to diverse outdoor environments.

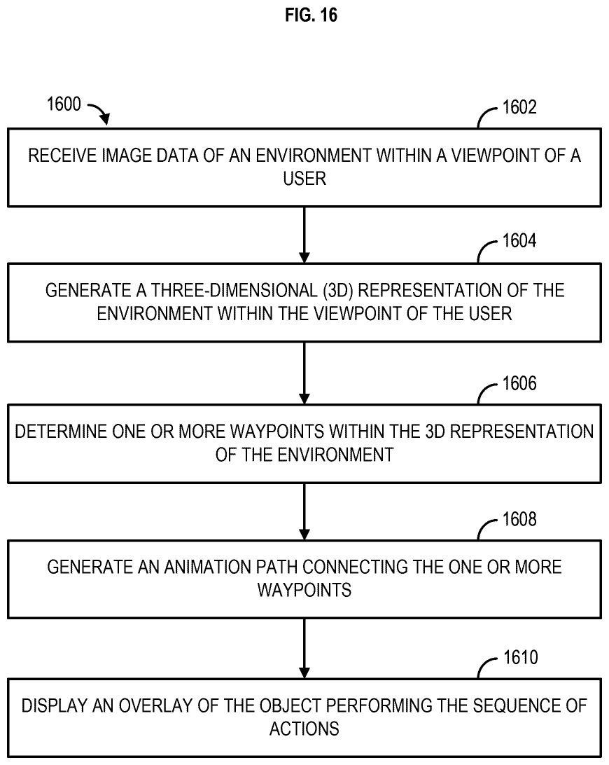

FIG. 16 shows a flowchart of example method 1600 for generating an animation path for a virtual character in an augmented reality environment. Method 1600 may be implemented by a computing device (e.g., computing device 101, electronic device 102, one or more servers 106, or any combination thereof). At step 1602, image data of an environment within a viewpoint of a user may be received. For example, a computing device (e.g., computing device 101, electronic device 102, one or more servers 106, etc.) may receive the image data of the environment within the viewpoint of a user. In one example, image data may be captured by an image sensor (e.g., image sensor 130). In another example, location information (e.g., GPS information) and a location database (e.g., Google maps, Google earth, etc.) may be accessed in order to retrieve image data, via the location database. The environment may comprise one or more characteristics. The one or more characteristics may comprise one or more of one or more objects, one or more buildings, one or more roads, one or more terrain features, and the like. The one or more terrain features may comprise one or more of one or more bodies of water, one or more hills, one or more plants, one or more mountains, and the like.

At step 1604, a three-dimensional (3D) representation of the environment within the viewpoint of the user may be generated. For example, the computing device (e.g., computing device 101, electronic device 102, one or more servers 106, etc.) may generate the 3D representation of the environment within the viewpoint of the user based on image data of the environment. As one example, the 3D representation of the environment may be generated from image data captured by an image sensor. As another example, the 3D representation of the environment may be generated based on the image data retrieved from the location database. As another example, the 3D representation of the environment based on a combination of the image data captured by the image sensor and the image data retrieved from the location database.

At step 1606, one or more waypoints within the 3D representation of the environment. For example, the computing device (e.g., computing device 101, electronic device 102, one or more servers 106, etc.) may implement a machine learning model to determine the one or more waypoints within the 3D representation of the environment for an object to perform the sequence of actions within the viewpoint of the user based on data indicative of the 3D representation of the environment within the viewpoint of the user and data indicative of a sequence of actions associated with the object. In an example, a plurality of sequences of actions associated with the object may be determined. For example, the plurality of sequences of actions may be stored (e.g., as a data file) on the computing device or may be stored in an external device (e.g., on a server such as server 106). The plurality of sequences of actions may be retrieved and a machine learning may be implemented to select the sequence of actions from the plurality of sequences of actions based on the plurality of sequences of actions and the data indicative of the 3D representation of the environment. For example, the sequence of actions may be selected from the plurality of sequences of actions based on a compatibility of the sequence of actions with one or more locations within the 3D representation of the environment. The object may comprise a virtual character or a virtual object.

At step 1608, an animation path connecting the one or more waypoints may be generated. For example, the computing device (e.g., computing device 101, electronic device 102, one or more servers 106, etc.) may generate the animation path connecting the one or more waypoints. In an example, the animation path connecting the one or more waypoints may be generated based on one or more of a location compatibility cost, a visibility cost, a distance cost, or a smoothness cost. The location compatibility cost may be based on a compatibility of an action of the sequence of actions with a voxel of the 3D representation of the environment. The visibility cost may be based on voxels of the 3D representation of the environment that are outside of a viewpoint of a camera capturing the environment and voxels of the 3D representation of the environment that are occluded by one or more characteristics of the environment. The distance cost may be based on a distance between a position of a user and voxels of the 3D representation of the environment. The smoothness cost may be based on one or more angle changes between consecutive segments of the animation path.

At step 1610, an overlay of the object performing the sequence of actions may be displayed. For example, the computing device (e.g., computing device 101, electronic device 102, one or more servers 106, etc.) may display, via an augmented reality display (e.g., display 170), an overlay of the object performing the sequence of actions according to the animation path within the viewpoint of the user. As an example, the user, wearing an AR headset, may watch the object animated via the synthesized animation path, performing the sequence of storyline actions at semantically compatible places within the user's surroundings in the real world.

In an example, one or more of a change in a position of the user of the computing device or a change in a viewpoint of the user may be determined. The animation path may be updated based on one or more of the change in the position of the user or the change in the viewpoint of the user. For example, the generated animation paths may be adapted to the user and the environment in order to deliver immersive augmented reality experiences.

The method 1600 illustrated in FIG. 16 provides a technical improvement over conventional augmented reality animation systems that fail to maintain coherent virtual character experiences as users move through real-world environments. Conventional systems suffer from a technical problem where animation paths are computed once based on initial environmental data and remain static, causing virtual characters to become occluded by environmental features or to exit the user's field of view when the user changes position or orientation. The method 1600 addresses this technical problem by receiving image data of the environment within the viewpoint of the user, generating a 3D representation that is specific to the user's current viewpoint, and determining waypoints based on A user-centric 3D representation. By generating the animation path based on visibility cost, distance cost, and smoothness cost factors that account for the user's perspective, and by displaying the overlay within the viewpoint of the user, the method 1600 ensures that the virtual character remains visible and appropriately positioned relative to the user throughout the augmented reality experience. The technical improvement is further enhanced by the capability to determine changes in user position or viewpoint and update the animation path accordingly, enabling real-time adaptation that maintains visual engagement without requiring the user to remain stationary. This architectural approach reduces computational waste associated with rendering virtual characters in positions that are not visible to the user while ensuring that storyline actions are performed at semantically appropriate locations within the user's observable environment.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method comprising:
generating, by a computing device, based on image data of an environment, a three-dimensional (3D) representation of the environment;
determining a sequence of actions associated with an object for insertion in an augmented reality display;
determining, by a machine learning model, based on data indicative of the 3D representation of the environment and data indicative of the sequence of actions associated with the object, one or more waypoints within the 3D representation of the environment for the object to perform the sequence of actions; and
generating an animation path connecting the one or more waypoints, wherein the object performs the sequence of actions in the augmented reality display along the animation path according to the one or more waypoints.

2. The method of claim 1, wherein the environment comprises one or more characteristics.

3. The method of claim 2, wherein the one or more characteristics comprise one or more of one or more objects, one or more buildings, one or more roads, or one or more terrain features, wherein the one or more terrain features comprise one or more of one or more bodies of water, one or more hills, one or more plants, or one or more mountains.

4. The method of claim 1, wherein the object comprises a virtual character or a virtual object.

5. The method of claim 1, further comprising determining a plurality of sequences of actions associated with the object.

6. The method of claim 5, wherein determining the sequence of actions associated with the object for insertion in the augmented reality display comprises:
selecting, by the machine learning model, based on the plurality of sequences of actions and the data indicative of the 3D representation of the environment, the sequence of actions from the plurality of sequences of actions.

7. The method of claim 1, wherein determining, by the machine learning model, based on the data indicative of the 3D representation of the environment and the data indicative of the sequence of actions associated with the object, the one or more waypoints within the 3D representation of the environment for the object to perform the sequence of actions comprise:
determining, by the machine learning model, based on the data indicative of the three-dimensional representation of the environment and the data indicative of the sequence of actions associated with the object, one or more compatibility values associated with one or more locations within the 3D representation of the environment; and
determining, based on the one or more compatibility values, the one or more waypoints within the 3D representation of the environment for the object to perform the sequence of actions.

8. The method of claim 1, wherein generating the animation path connecting the one or more waypoints comprises:
generating, based on one or more of a location compatibility cost, a visibility cost, a distance cost, or a smoothness cost, the animation path connecting the one or more waypoints.

9. The method of claim 8, wherein the location compatibility cost is based on a compatibility of an action of the sequence of actions with a voxel of the 3D representation of the environment, wherein the visibility cost is based on voxels of the 3D representation of the environment that are outside of a viewpoint of a camera capturing the environment and voxels of the 3D representation of the environment that are occluded by one or more characteristics of the environment, wherein the distance cost is based on a distance between a position of a user and voxels of the 3D representation of the environment, and wherein the smoothness cost is based on one or more angle changes between consecutive segments of the animation path.

10. The method of claim 1, further comprising:
generating an overlay of the object performing the sequence of actions according to the animation path; and
displaying, via the augmented reality display, the overlay of the object performing the sequence of actions according to the animation path within a viewpoint of a user of the augmented reality display.

11. The method of claim 1, further comprising:
determining one or more of a change in a position of a user of the computing device or a change in a viewpoint of the user; and
updating, based on one or more of the change in the position of the user or the change in the viewpoint of the user, the animation path.

12. A method comprising:
receiving, by a computing device, image data of an environment within a viewpoint of a user;
generating, based on the image data of the environment, a three-dimensional (3D) representation of the environment within the viewpoint of the user;
determining, by a machine learning model, based on data indicative of the 3D representation of the environment within the viewpoint of the user and data indicative of a sequence of actions associated with an object, one or more waypoints within the 3D representation of the environment for the object to perform the sequence of actions within the viewpoint of the user;
generating an animation path connecting the one or more waypoints; and
displaying, via an augmented reality display, an overlay of the object performing the sequence of actions according to the animation path within the viewpoint of the user.

13. The method of claim 12, wherein the environment comprises one or more characteristics.

14. The method of claim 13, wherein the one or more characteristics comprise one or more of one or more objects, one or more buildings, one or more roads, or one or more terrain features, wherein the one or more terrain features comprise one or more of one or more bodies of water, one or more hills, one or more plants, or one or more mountains.

15. The method of claim 12, wherein the object comprises a virtual character or a virtual object.

16. The method of claim 12, wherein determining, by the machine learning model, based on the data indicative of the 3D representation of the environment within the viewpoint of the user and the data indicative of the sequence of actions associated with the object, the one or more waypoints within the 3D representation of the environment for the object to perform the sequence of actions within the viewpoint of the user comprises:
determining, by the machine learning model, based on the data indicative of the 3D representation of the environment and the data indicative of the sequence of actions associated with the object, one or more compatibility values associated with one or more locations within the 3D representation of the environment; and
determining, based on the one or more compatibility values, the one or more waypoints within the 3D representation of the environment for the object to perform the sequence of actions.

17. The method of claim 12, wherein generating the animation path connecting the one or more waypoints comprises:
generating, based on one or more of a location compatibility cost, a visibility cost, a distance cost, or a smoothness cost, the animation path connecting the one or more waypoints.

18. The method of claim 17, wherein the location compatibility cost is based on a compatibility of an action of the sequence of actions with a voxel of the 3D representation of the environment, wherein the visibility cost is based on voxels of the three-dimensional representation of the environment that are outside of a viewpoint of a camera capturing the environment and voxels of the 3D representation of the environment that are occluded by one or more characteristics of the environment, wherein the distance cost is based on a distance between a position of the user and voxels of the 3D representation of the environment, and wherein the smoothness cost is based on one or more angle changes between consecutive segments of the animation path.

19. The method of claim 12, further comprising:
determining one or more of a change in a position of the user or a change in the viewpoint of the user; and
updating, based on one or more of the change in the position of the user or the change in the viewpoint of the user, the animation path.

20. The method of claim 12, further comprising
determining a plurality of sequences of actions associated with the object; and
selecting, by the machine learning model, based on the plurality of sequences of actions and the data indicative of the 3D representation of the environment, the sequence of actions from the plurality of sequences of actions.
